(19) United States
(12) Patent Application Publication
(10) Pub. No.: US 2017/0070188 A1
(43) Pub. Date: Mar. 9, 2017

(54) ASYMMETRIC WAVE PHOTOVOLTAIC SYSTEM

(71) Applicant: TENKSOLAR, INC., Minneapolis, MN (US)

(72) Inventors: Dallas W. Meyer, Prior Lake, MN (US); Lowell J. Berg, Eden Prairie, MN (US); Richard Amy, Bloomington, MN (US); Thomas L. Murnan, Bloomington, MN (US); Lance E. Stover, Eden Prairie, MN (US); Raymond W. Knight, Chanhassen, MN (US); Kevin Batko, Bloomington, MN (US); Dan Heneman, Shakopee, MN (US); Steve Sazama, Prior Lake, MN (US); Larry Weiss, Minneapolis, MN (US); Timothy C. Johnson, Eden Prairie, MN (US)

(21) Appl. No.: 15/356,272

(22) Filed: Nov. 18, 2016

Related U.S. Application Data
(63) Continuation-in-part of application No. 14/919,648, filed on Oct. 21, 2015.
(60) Provisional application No. 62/257,050, filed on Nov. 18, 2015.
(60) Provisional application No. 62/264,619, filed on Dec. 8, 2015.
(60) Provisional application No. 62/296,949, filed on Feb. 18, 2016.
(60) Provisional application No. 62/299,929, filed on Feb. 25, 2016.
(60) Provisional application No. 62/305,921, filed on Mar. 9, 2016.
(60) Provisional application No. 62/318,074, filed on Apr. 4, 2016.
(60) Provisional application No. 62/318,112, filed on Apr. 4, 2016.
(60) Provisional application No. 62/321,136, filed on Apr. 11, 2016.
(60) Provisional application No. 62/353,506, filed on Jun. 22, 2016.
(60) Provisional application No. 62/363,709, filed on Jul. 18, 2016.
(60) Provisional application No. 62/369,611, filed on Aug. 1, 2016.
(60) Provisional application No. 62/393,649, filed on Sep. 13, 2016.
(60) Provisional application No. 62/393,652, filed on Sep. 13, 2016.
(60) Provisional application No. 62/066,689, filed on Oct. 21, 2014.
(60) Provisional application No. 62/153,940, filed on Apr. 28, 2015.
(60) Provisional application No. 62/153,948, filed on Apr. 28, 2015.
(60) Provisional application No. 62/153,949, filed on Apr. 28, 2015.
(60) Provisional application No. 62/153,955, filed on Apr. 28, 2015.
(60) Provisional application No. 62/153,957, filed on Apr. 28, 2015.
(60) Provisional application No. 62/153,960, filed on Apr. 28, 2015.
(60) Provisional application No. 62/210,271, filed on Aug. 26, 2015.

(51) Int. Cl. H02S 30/10; H02S 20/23

(52) U.S. Cl. CPC H02S 30/10; H02S 20/23

(57) ABSTRACT

An asymmetric wave photovoltaic (PV) system includes at least one asymmetric wavelet coupled. The at least one asymmetric wavelet includes front and rear PV modules of equal size. The front and rear PV modules are coupled together to form a peak of the at least one asymmetric wavelet. The front PV module is supported at a first angle. The rear PV module is supported at a second angle that is different than the first angle.

### CROSS-REFERENCE TO RELATED APPLICATIONS

This application claims the benefit of and priority to:
U.S. Provisional Patent App. No. 62/257,050, filed Nov. 18, 2015;
U.S. Provisional Patent App. No. 62/264,619, filed Dec. 8, 2015;
U.S. Provisional Patent App. No. 62/296,949, filed Feb. 18, 2016;
U.S. Provisional Patent App. No. 62/299,929, filed Feb. 25, 2016;
U.S. Provisional Patent App. No. 62/305,921, filed Mar. 9, 2016.
U.S. Provisional Patent App. No. 62/318,074, filed Apr. 4, 2016.
U.S. Provisional Patent App. No. 62/318,112, filed Apr. 4, 2016;
U.S. Provisional Patent App. No. 62/321,136, filed Apr. 11, 2016;
U.S. Provisional Patent App. No. 62/353,506, filed Jun. 22, 2016;
U.S. Provisional Patent App. No. 62/363,709, filed July, 2016;
U.S. Provisional Patent App. No. 62/369,611, filed Aug. 1, 2016;
U.S. Provisional Patent App. No. 62/393,649, filed Sep. 13, 2016; and
U.S. Provisional Patent App. No. 62/393,652, filed Sep. 13, 2016;

This application also is a continuation-in-part of U.S. patent application Ser. No. 14/919,648, filed Oct. 21, 2015, which claims the benefit of and priority to:
U.S. Provisional Patent Application Ser. No. 62/066,689, filed Oct. 21, 2014;
U.S. Provisional Patent Application Ser. No. 62/153,940, filed Apr. 28, 2015;
U.S. Provisional Patent Application Ser. No. 62/153,948, filed Apr. 28, 2015;
U.S. Provisional Patent Application Ser. No. 62/153,949, filed Apr. 28, 2015;
U.S. Provisional Patent Application Ser. No. 62/153,955, filed Apr. 28, 2015;
U.S. Provisional Patent Application Ser. No. 62/153,957, filed Apr. 28, 2015;
U.S. Provisional Patent Application Ser. No. 62/153,960, filed Apr. 28, 2015; and
U.S. Provisional Patent Application Ser. No. 62/210,271, filed Aug. 26, 2015.

The foregoing patent applications are incorporated herein by reference.

### FIELD

Some embodiments described herein generally relate to an asymmetric wave photovoltaic (PV) system.

### BACKGROUND

Unless otherwise indicated herein, the materials described herein are not prior art to the claims in the present application and are not admitted to be prior art by inclusion in this section.

Some PV or solar energy systems include multiple PV modules, sometimes referred to as solar panels, combined together in an array to generate electricity from sunlight based on the photoelectric effect. Such PV or solar energy systems sometimes include reflector panels/concentrators together with the solar panels.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, an asymmetric wave PV system includes multiple asymmetric wavelets arranged in rows. Each of the asymmetric wavelets includes front and rear PV modules of equal size. Within each asymmetric wavelet, two upper corners of the front PV module and two upper corners of the rear PV module are coupled together to form a peak of the asymmetric wavelet. For each asymmetric wavelet, the front PV module includes two lower corners supported at a first height such that the front PV module is arranged at a first angle relative to horizontal For each asymmetric wavelet, the rear PV module includes two lower corners supported at a second height that is different than the first height such that the rear PV module is arranged at a second angle relative to horizontal that is different than the first angle.

In another example embodiment, an asymmetric wave PV system includes at least one asymmetric wavelet coupled. The at least one asymmetric wavelet includes front and rear PV modules of equal size. The front and rear PV modules are coupled together to form a peak of the at least one asymmetric wavelet. The front PV module is supported at a first angle. The rear PV module is supported at a second angle that is different than the first angle.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1A is a perspective view of an example asymmetric wave PV system;

FIG. 1B is a perspective view of another example asymmetric wave PV system;

FIG. 2A is a side view of an example first configuration of a portion of the asymmetric wave PV system of FIG. 1B;

FIG. 2B is a side view of an example second configuration of a portion of the asymmetric wave PV system of FIG. 1B;

FIG. 3 is a perspective view of a wind deflector that may be implemented in the asymmetric wave PV system of FIG. 1B;

FIG. 4A is a perspective view of two example fin assemblies that may be implemented in one or more asymmetric wave PV systems;

FIG. 4B is an exploded perspective view of one of the fin assemblies of FIG. 4A;

FIGS. 5A and 5B is each an end view of an example rail that may be implemented in one or more asymmetric wave PV systems;

FIGS. 6A and 6B are detail perspective views of a fin of FIG. 4A mechanically coupled to the rail of FIG. 5B;

FIGS. 7A and 7B are detail elevation views of portions of front and rear PV modules of FIG. 1B, one of the fin assemblies of FIG. 4A, and a top of the rail of FIG. 5B mechanically coupled together;

FIG. 8 is an overhead view of an example PV module that may be implemented in one or more asymmetric wave PV systems;

FIG. 9A is an overhead detail view of a portion of another asymmetric wave PV system;

FIG. 9B is an overhead view of the asymmetric wave PV system of FIG. 9A;

FIG. 10 is a perspective view of the system of FIG. 1B with various example parameters;

FIG. 11 includes a side view of a portion of the system of FIG. 1B;

FIGS. 12A and 12B are elevation views of a ballast clip that may be implemented in one or more of the PV systems described herein;

FIG. 13 illustrates an example method to add ballast to the system of FIG. 1B;

FIG. 14A is a perspective view of a portion of the system of FIG. 1B in an example ground mount environment;

FIG. 14B is a detail perspective view of a portion of FIG. 14A;

FIG. 14C is a detail perspective view of an example connection between a surface footing and a rail of FIGS. 14A and 14B;

FIG. 15A is a perspective view of a tie-down that may be implemented in one or more of the PV systems described herein;

FIG. 15B is a detail perspective view of a portion of the tie-down of FIG. 15A;

FIG. 16A is a perspective view of an example asymmetric wave PV system that includes snow feet;

FIG. 16B is a detail perspective view of a portion of the system of FIG. 16A;

FIG. 16C is a detail perspective view of another portion of the system of FIG. 16A;

FIG. 17 is an exploded perspective view of a snow foot of FIG. 16B;

FIG. 18 illustrates an example method to install cradles of the snow feet of FIG. 16A in an existing PV system;

FIG. 19 is an elevation view of an example material stackup that may be implemented in a PV module;

FIGS. 20A and 20B include views of a flat PV module and a curved PV module;

FIG. 21 illustrates a perspective view of another curved PV module;

FIG. 22 is a simplified side view of two asymmetric wave PV systems;

FIG. 23 is a graphic of results of a Fresnel mode for a curved PV module and a flat PV module;

FIGS. 24A and 24B include simplified side views of the systems two asymmetric wave PV systems of FIG. 22, along with ray diagrams for incoming illumination and reflected illumination at different angles than in FIG. 22;

FIG. 25A is an overhead perspective view of an example implementation of the system of FIG. 1B installed on a sloped installation surface;

FIG. 25B is a detailed perspective view of a portion of FIG. 25A,

all arranged in accordance with at least one embodiment described herein.

### DETAILED DESCRIPTION OF SOME EXAMPLE EMBODIMENTS

Some embodiments described herein generally relate to an asymmetric wave PV system. The asymmetric wave PV system includes multiple asymmetric wavelets arranged in rows and coupled through fin assemblies to rails. Each of the asymmetric wavelets includes a front PV module (or front solar panel) and a rear PV module (or rear solar panel) coupled together to form a peak of the asymmetric wavelet. The front and rear PV modules may be of equal size (or at least nominally equal size within manufacturing tolerances). Each asymmetric wavelet may be asymmetric in the sense that the front PV module may be coupled to the rails at a first angle while the rear PV module may be coupled to the rails at a second angle that is different than the first angle. Various advantages associated with the asymmetry are described below and/or will become apparent from the following description.

Other asymmetric wave PV systems may achieve asymmetry by using elements with different length. For instance, such PV systems may include PV modules of a first length coupled to reflectors of a second length that is different than the first length. Such asymmetric wave PV systems require PV modules and/or reflectors of different sizes, thereby doubling the types of panel-type elements required to form such asymmetric wave PV systems.

Other PV systems include PV modules arranged in symmetric waves. Some asymmetric and/or symmetric wave PV systems include PV modules and/or reflectors arranged at relatively shallow angles (e.g., 10 degrees or less) to horizontal. Such PV systems may require a peak support element directly beneath the peak of each wave or wavelet to support the peak. Alternatively or additionally, such PV systems may have poor lift performance (e.g., a susceptibility to wind lift) and may thereby require a significant amount of ballast. In comparison, the asymmetric wave PV systems described herein may omit peak support elements directly beneath the peak of each wavelet (thereby simplifying assembly and/or improving under-module space/access) and may have relatively better lift performance such that ballast is not required except for more windy installation locations.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

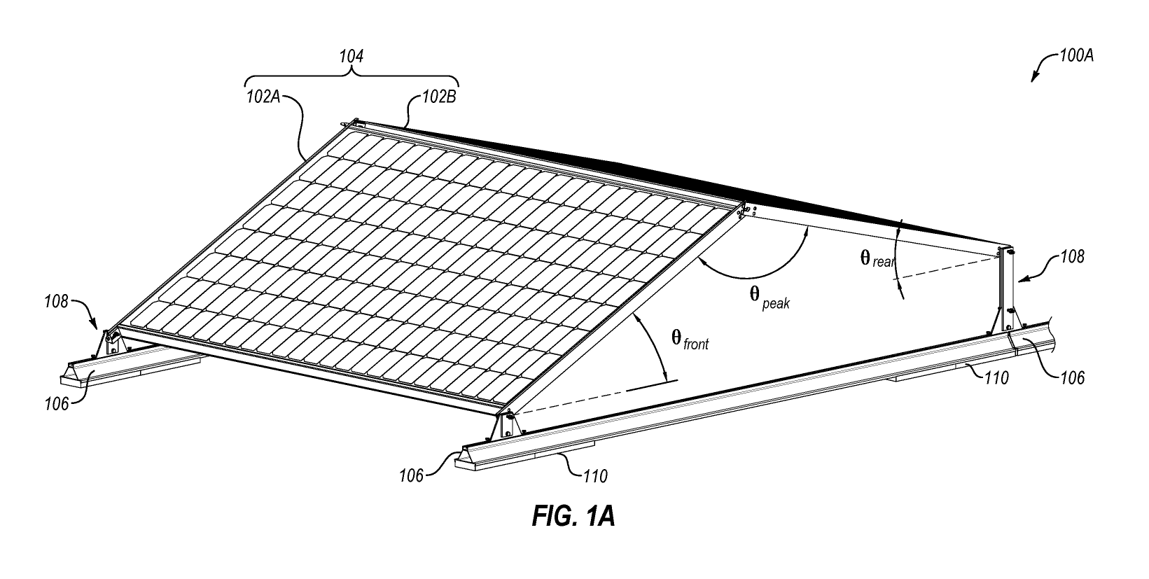

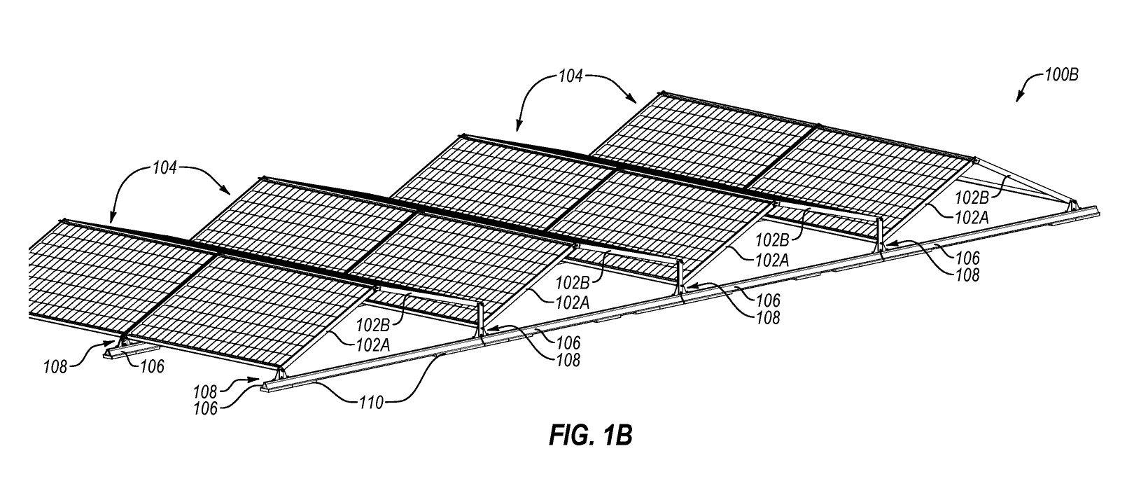

FIG. 1A is a perspective view of an example asymmetric wave PV system 100A (hereinafter “system 100A”), arranged in accordance with at least one embodiment described herein. The system includes two PV modules 102A and 102B (hereinafter generically PV module or modules 102) arbitrarily referred to individually as a front PV module 102A or a rear PV module 102B. The PV modules 102 together form a wavelet 104 with a peak where upper ends of the PV modules 102 are coupled together.

The PV modules 102 may be equal in size. Being equal in size may refer to being nominally equal in size, e.g., equal in size (e.g., length and width) within manufacturing tolerances, which can be as large as several millimeters in some embodiments, or even more or less than several millimeters.

The system 100A additionally includes multiple rails 106 to which the PV modules 102 are coupled through multiple fin assemblies 108. In particular, in some embodiments, each of the PV modules 102 may be directly coupled to one or more of the fin assemblies 108 while each of the fin assemblies 108 may be directly coupled to one or more of the rails 106. Only some of the rails 106 and fin assemblies 108 are labeled in FIG. 1A for simplicity.

At the peak of the wavelet 104, the PV modules 102 are coupled together at an angle θₚₑₐₖ (sometimes referred to as the “peak angle”) between the PV modules 102. The angle θₚₑₐₖ may be less than or equal to 160° in some embodiments. If the angle θₚₑₐₖ is greater than 160°, forces in the system 100A (e.g., due to at least the weight of the PV modules 102) may be sufficiently large that, with some deflection of one or both of the PV modules 102, the peak can snap through. As such, in some embodiments described herein, the angle θₚₑₐₖ may be less than or equal to 160°.

The front PV module 102A may be coupled to the rails 106 at a first angle θ_{front} relative to a nominally horizontal installation surface or other horizontal reference plane. The rear PV module 102B may be coupled to the rails 106 at a second angle θᵣₑₐᵣ relative to the nominally horizontal installation surface or other horizontal reference plane. In some embodiments, the first and second angles θ_{front} and θᵣₑₐᵣ of the PV modules 102 may be measured relative to the rails 106 and/or relative to a plane defined by the rails 106 as a proxy for the nominally horizontal installation surface. The first angle θ_{front} and the second angle θᵣₑₐᵣ are unequal in some embodiments. For instance, in an example embodiment, the first angle θ_{front} may be about 25° and the second angle θᵣₑₐᵣ may be about 16°. More generally, the first angle θ_{front} may be in a range from 15° to 35° and the second angle θᵣₑₐᵣ may be in a range from 10° to 30°. In other embodiments, the first angle θ_{front} and/or the second angle θᵣₑₐᵣ may have different values than those stated.

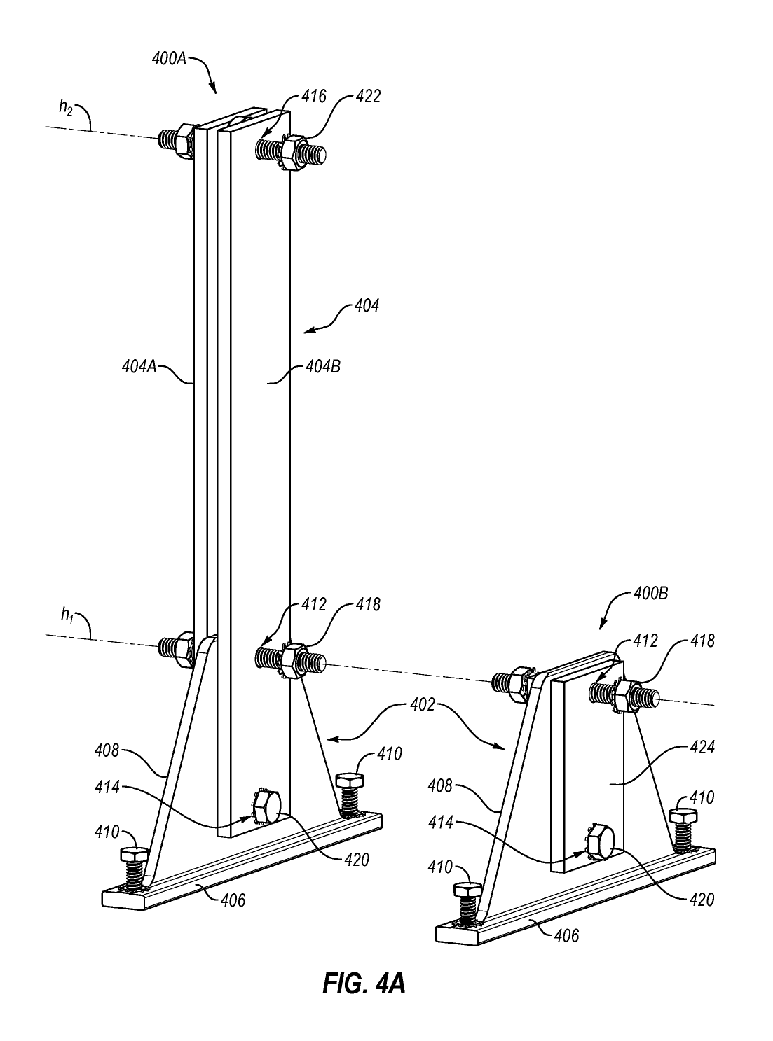

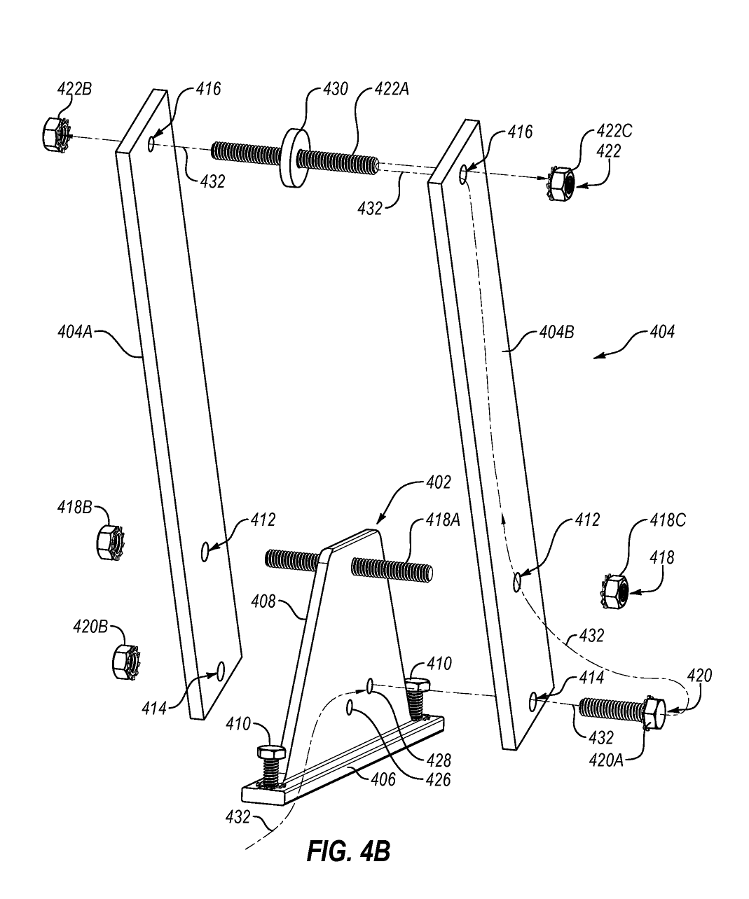

Accordingly, the wavelet 104 of FIG. 1A may be asymmetric in the sense that even though the front PV module 102A and the rear PV module 102B are equal in size, they are nevertheless arranged relative to horizontal at unequal angles, e.g., the first angle θ_{front} and the second angle θᵣₑₐᵣ where θ_{front} is i not equal to θᵣₑₐᵣ. Wavelets 104 that have such asymmetry may be referred to as asymmetric wavelets. The asymmetry in this and other embodiments may be achieved by coupling lower ends of the PV modules 102 to the rails 106 (e.g., through the fin assemblies 108) at different heights above the rails 106. For instance, in the example of FIG. 1A, two lower corners of the front module 102A may be coupled to two of the fin assemblies 108 at a first height h₁ (see FIG. 4A) above the rails 106 while two lower corners of the rear module 102B may be coupled to two other fin assemblies 108 at a second height h₂ (see FIG. 4A) above the rails 106 that is higher than the first height h₁.

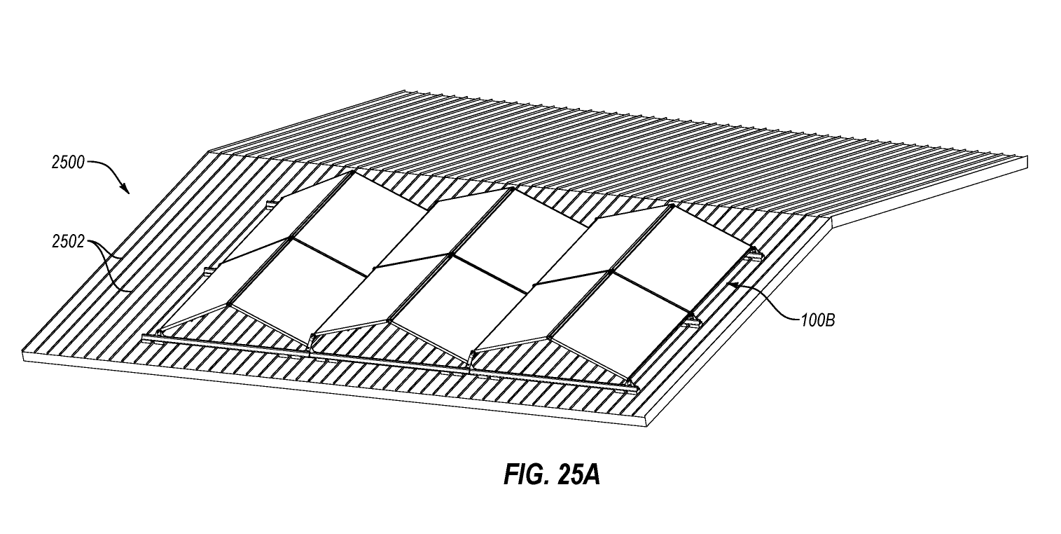

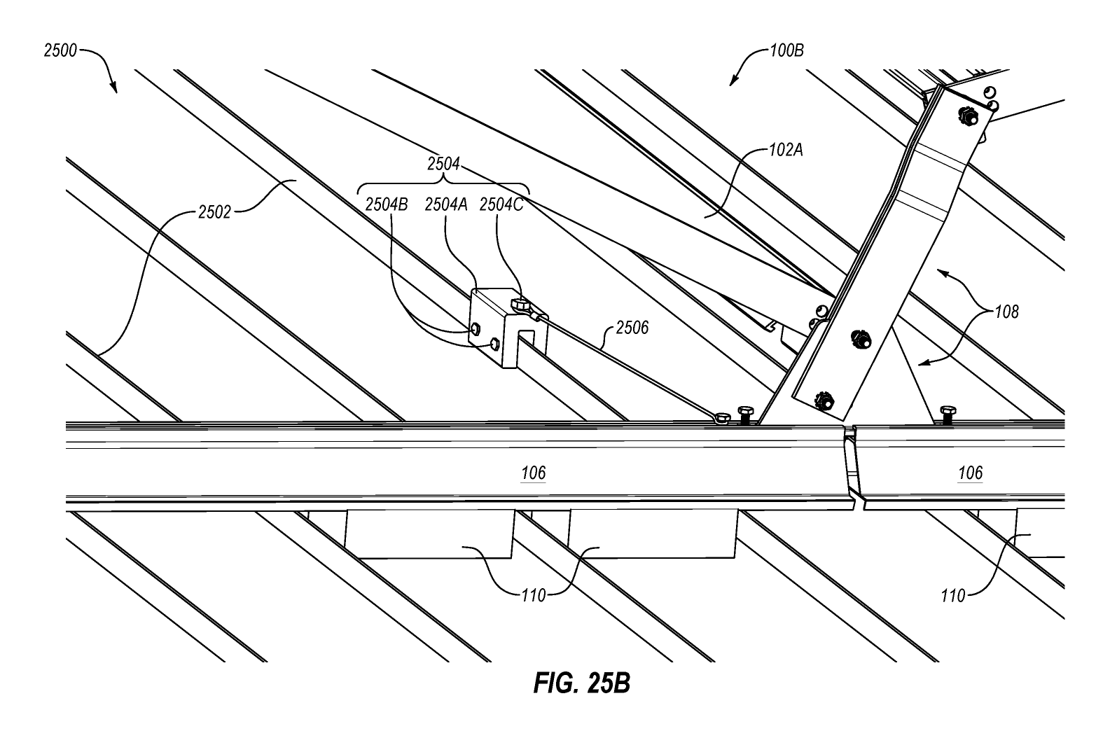

In some embodiments, the system 100A may additionally include one or more pads 110. The pads 110 may be disposed between the rails 106 and the installation surface. In some implementations, the installation surface may include ridges and/or other features as described below with respect to FIGS. 25A and 25B. It may be desirable to avoid loading the ridges and/or other features with the weight of the system 100A. In these and other embodiments, the pads 110 may be placed in locations of the installation surface other than the ridges and/or other features and may be thicker than heights of the ridges and/or other features to avoid loading the ridges and/or other features with the weight of the system 100A. Alternatively or additionally, the system 100A may be installed on one or more surface footing pillars with or without one or more pads 110 disposed therebetween. Additional details regarding example embodiments of the pads 110 and surface footings are described elsewhere herein. In still other embodiments, the system 100A may include one or more inverters and/or other elements or components.

FIG. 1B is a perspective view of another example asymmetric wave PV system 100B (hereinafter “system 100B”), arranged in accordance with at least one embodiment described herein. The system 100B includes multiple wavelets 104, rails 106, fin assemblies 108, and pads 110. Only some of the wavelets 104, rails 106, fin assemblies 108, and pads 110 are labeled in FIG. 1B for simplicity. Each of the wavelets 104, rails 106, fin assemblies 108, and pads 110 may respectively include or correspond to the wavelet 104, rails 106, fin assemblies 108, and pads 110 of FIG. 1A.

FIG. 1B additionally illustrates an example arrangement of the wavelets 104 with respect to each other in which the wavelets 104 are arranged in rows that run generally normal or perpendicular to the rails 106. In the example of FIG. 1B, the system 100B includes four rows of wavelets 104 with two wavelets 104 in each row.

Similar to FIG. 1A, each of the wavelets 104 of FIG. 1B may include both a front PV module 102A and a rear PV module 102B. Only some of the front and rear PV modules 102A and 102B are labeled in FIG. 1B for simplicity. Within each wavelet 104, two upper corners of the front PV module 102A and two upper corners of the rear PV module 102B are coupled together to form a peak of the wavelet 104. More generally, the two PV modules 102 that form each wavelet 104 may be coupled together at any location(s) along upper edges of the two PV modules 102 (and not necessarily at their two upper corners) so as to form a peak of each wavelet 104. While FIGS. 1A and 1B illustrate the two PV modules 102 of each wavelet 104 being coupled together at upper corners of each, in other embodiments, the two PV modules 102 of each wavelet 104 may be coupled together at the middle of each upper edge and/or at one or more other non-corner or corner locations of the upper edges of the two PV modules 102 of each wavelet 104.

Similar to FIG. 1A, each of the front PV modules 102A of FIG. 1B includes two lower corners coupled to first and second fin assemblies 108 at the first height h₁ above the rails 106 such that each of the front PV modules 102A is arranged at the first angle θ_{front}. Similarly, each of some or all of the rear PV modules 102B includes two lower corners coupled to third and fourth fin assemblies 108 at the second height h₂ above the rails 106 that is different than the first height h₁ such that each of some or all of the rear PV modules 102B is arranged at the second angle θᵣₑₐᵣ.

In some embodiments, the peak of each wavelet 104 in FIGS. 1A and 1B is unsupported except for support provided by the front and rear PV modules 102A, 102B as coupled together at the two upper corners of each and as coupled to the rails 106 through the fin assemblies 108. As mentioned above, other PV systems may require a peak support element directly beneath the peak of each wave or wavelet to support the peak. Embodiments described herein omit such peak support elements, which may simplify assembly, improve under-module space and/or access, and/or provide other benefits.

The systems 100A, 100B of FIGS. 1A and 1B may be aligned so that the front and rear PV modules 102A, 102B face a desired direction. In this regard, when the systems 100A and 100B are installed at an installation site, a normal reference line coming off a given one of the PV modules 102 can be decomposed into both a vertical component and a horizontal component. The horizontal component of the normal reference line points in the direction that the PV module 102 is said to be facing.

In some embodiments, the systems 100A, 100B of FIGS. 1A and 1B may be aligned so that the PV modules 102 at the relatively steeper angle, e.g., the front PV modules 102A at the first angle θ_{front} in this example, are arranged to face south, or west, or both partially south and partially west. In comparison, the PV modules 102 at the relatively shallower angle, e.g., the rear PV modules 102B at the second angle θᵣₑₐᵣ in this example, may be arranged to face an opposite direction from the PV modules 102 at the relatively steeper angle. For instance, if the front PV modules 102A are arranged to face south, the rear PV modules 102B may be arranged to face north. As another example, if the front PV modules 102A are arranged to face west, the rear PV modules 102B may be arranged to face east. As yet another example, if the front PV modules 102A are arranged to face southwest, the rear PV modules 102B may be arranged to face northeast. The foregoing may apply to installation sites in the Northern Hemisphere and may be reversed for installation sites in the Southern Hemisphere. For instance, in the Southern Hemisphere, the front PV modules 102A at the relatively steeper first angle θ_{front} may be arranged to face north and/or east while the rear PV modules 102B at the relatively shallower second angle θᵣₑₐᵣ may be arranged to face south and/or west.

In some embodiments, the south and/or west facing PV modules 102 in Northern Hemisphere installations, e.g., the front PV modules 102A in this example, may have a higher efficiency than the north and/or east facing PV modules 102, e.g., the rear PV modules 102B in this example. For instance, PV cells included in each of the front PV modules 102A may have a higher efficiency than PV cells included in each of the rear PV modules 102B. The foregoing may be reversed for installations in the Southern Hemisphere.

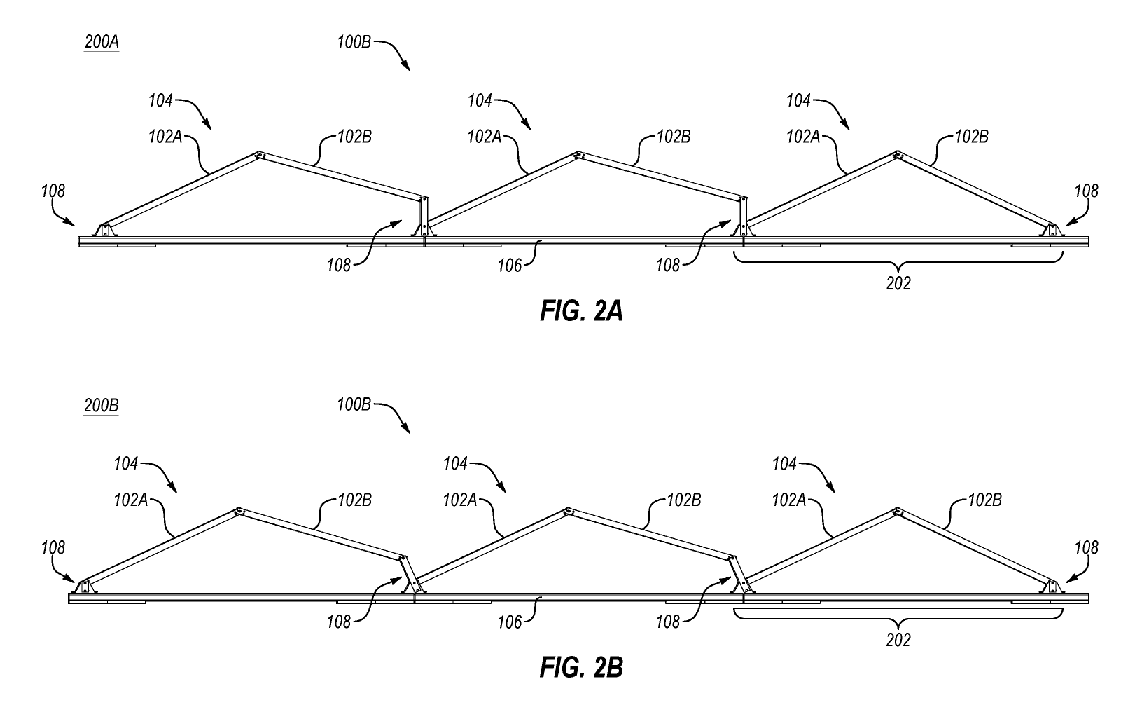

FIG. 2A is a side view of an example first configuration 200A of a portion of the system 100B of FIG. 1B, arranged in accordance with at least one embodiment described herein. In the first configuration 200A of FIG. 2A, the fin assemblies 108 may be configured to support rear PV modules 102B in each wavelet 104 and adjacent front PV modules 102A in adjacent wavelets 104 with a relatively small or nonexistent horizontal offset between lower edges of the rear PV module 102B in a given wavelet 104 and the adjacent front PV module 102A in the adjacent wavelet 104. For instance, in FIG. 2A, the rear PV module 102B in the leftmost wavelet 104 and the front PV module 102A in the middle wavelet 104 may have a relatively small or nonexistent horizontal offset between lower edges thereof. Notwithstanding the relatively small or nonexistent horizontal offset, it can be seen from FIG. 2A that the lower edge of each rear PV module 102B in each wavelet 104 is vertically offset above the lower edge of each adjacent front PV module 102A in the adjacent wavelet 104.

FIG. 2B is a side view of an example second configuration 200B of a portion of the system 100B of FIG. 1B, arranged in accordance with at least one embodiment described herein. In the second configuration 200B of FIG. 2B, the fin assemblies 108 may be configured to support rear PV modules 102B in each wavelet 104 and adjacent front PV modules 102A in adjacent wavelets 104 with a relatively larger horizontal offset between their lower edges than in the first configuration 200A of FIG. 2A. For instance, in FIG. 2A, the rear PV module 102B in the leftmost wavelet 104 and the front PV module 102A in the middle wavelet 104 have a relatively larger horizontal offset between their lower edges than in FIG. 2A. In an example embodiment, the relatively larger horizontal offset may arise from tilting a riser or other portion of each of the fin assemblies 108 frontward, e.g., toward a front of the system 100A, as described in more detail below. In this and other Figures, the “front” of an asymmetric wave PV system may refer to the end of the asymmetric wave PV system which includes front PV modules 102A exposed thereat. The “rear” of a system may refer to an end of the asymmetric wave PV system that is opposite the front of the asymmetric wave PV system. As in FIG. 2A, it can be seen from FIG. 2B that the lower edge of each rear PV module 102B in each wavelet 104 is vertically offset above the lower edge of each adjacent front PV module 102A in the adjacent wavelet 104.

As can be appreciated from FIGS. 1B-2B, wavelets 104 that are asymmetric (such as the leftmost and middle wavelets 104 of FIGS. 2A and 2B) have a gap between the lower edge of each rear PV module 102B and the installation surface that is larger than the gap between the lower edge of each front PV module 102A and the installation surface. To reduce wind lift at the rear of the system 100B and/or for other reasons, in a rear row 202 of wavelets 104, the gap between the installation surface and the lower edge of each rear PV module 102B may be completely or partially closed. For instance, in FIGS. 1B-2B, the gap is partially closed by coupling the bottom of each rear PV module 102B in each wavelet 104 in the rear row 202 to the corresponding fin assembly 108 at the same first height h₁ as the bottom of each front PV module 102A. In the example of FIGS. 1B-2B, the wavelets 104 in the rear row 202 of the system 100B are thus symmetric wavelets as these wavelets 104 include front and rear PV modules 102A and 102B of equal size coupled to fin assemblies 108 at the same first height to form equal (e.g., symmetric) front and rear angles θ_{front} and θᵣₑₐᵣ relative to horizontal.

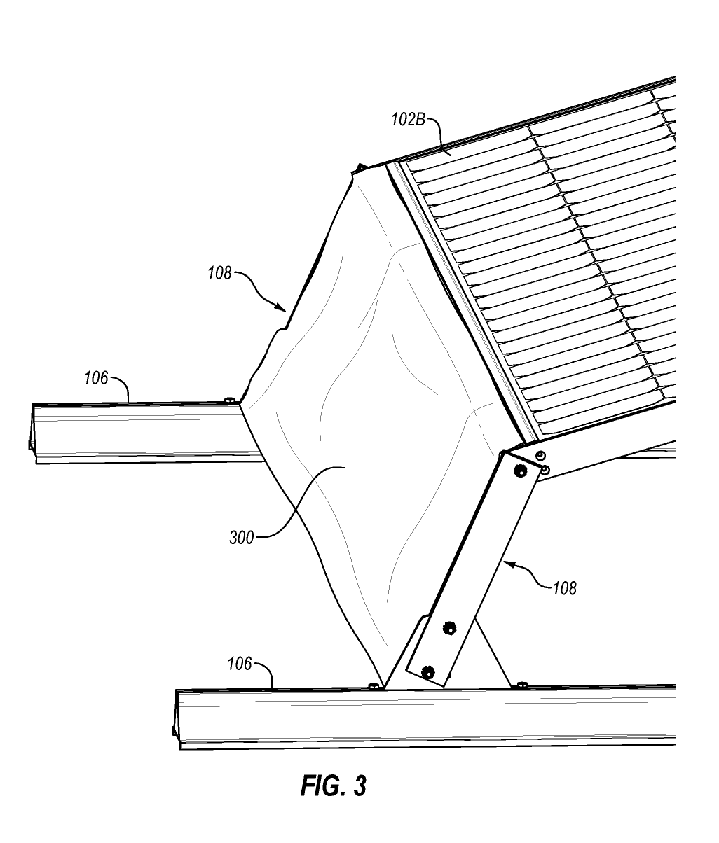

FIG. 3 is a perspective view of a wind deflector 300 that may be implemented in the system 100B, arranged in accordance with at least one embodiment described herein. The wind deflector 300 may be implemented in the system 100B to at least partially close the gap between the lower edge of a corresponding rear PV module 102B in a wavelet 104 of the rear row 202 (FIGS. 2A and 2B) of wavelets 104 and the installation surface while maintaining the wavelet 104 as an asymmetric wavelet.

The wind deflector 300 may be coupled to a portion (e.g., a riser) of each of the fin assemblies 108 that couples the rear PV module 102B to the rails 106. Alternatively or additionally, the wind deflector 300 may be coupled to one or more of: the rails 106, the rear PV module 102B, and/or some other portion of the fin assemblies 108.

The wind deflector 300 may include metal (such as sheet metal), wood, a composite laminate, plastic, cloth, or other suitable material.

In the example of FIG. 3, there is a one-to-one correspondence between the wind deflector 300 and each gap or rear PV module 102B of the wavelet 104 in the rear row 202 of wavelets 104. In particular, there is one wind deflector 300 per gap (or per rear PV module 102B) in the example of FIG. 3. In other embodiments, there may be two or more wind deflectors 300 per gap, or one wind deflector 300 per two or more gaps.

In still other embodiments, the system 100B may intermix the solutions of FIGS. 2A-2B and 3. For instance, at least one rear PV module 102B in the rear row 202 of wavelets 104 may be part of an asymmetric wavelet 104 with the wind deflector 300 disposed in the gap between the lower edge of the rear PV module 102B and the installation surface as in FIG. 3, while at least one other rear PV module 102B in the rear row 202 of wavelets 104 may be part of a symmetric wavelet 104 with its bottom at the same first height h₁ as the bottom of the corresponding front PV module 102A to at least partially close the gap as in FIGS. 2A and 2B.

By at least partially closing the gap between the installation surface and the lower edge of each rear PV module 102B in each wavelet 104 in the rear row 202 as described with respect to FIGS. 2A-3, embodiments described herein may reduce or eliminate the entrance of wind under the lower edge of the rear PV modules 102B in the rear row 202 of wavelets 104 and/or may reduce or eliminate pressurization or lift beneath the rear row 202 of wavelets 104.

FIG. 4A is a perspective view of two example fin assemblies 400A, 400B that may be implemented in one or more asymmetric wave PV systems, arranged in accordance with at least one embodiment described herein. Each of the fin assemblies 108 illustrated in FIGS. 1A-3 may be the same as or similar to at least one of the fin assemblies 400A, 400B. In an example embodiment, some of the fin assemblies 108 may be the same as or similar to the fin assembly 400A, while others of the fin assemblies 108 may be the same as or similar to the fin assembly 400B.

The fin assembly 400A may generally be used where lower edges of the front PV modules 102A are to be supported at the first height h₁ and lower edges of adjacent rear PV modules 102B are to be supported at the second height h₂ that is different than the first height h₁.

In comparison, the fin assembly 400B may generally be used where lower edges of PV modules 102 (front or rear) are to be supported at the first height h₁ and without supporting lower edges of any PV modules 102 at the second height h₂. For instance, the fin assembly 400B may be implemented as each of the fin assemblies 108 along the front of the system 100B of FIGS. 1B-2B to support lower edges of the front PV modules 102A in the front row of wavelets 104 at the first height h₁. In some implementations without the wind deflector 300 (FIG. 3) to at least partially fill the gap between the installation surface and the lower edge of each rear PV module 102B in the rear row 202 of wavelets 104, the fin assembly 400B may optionally also be implemented as each of the fin assemblies 108 along the rear of the system 100B of FIGS. 1B-2B to support lower edges of the rear PV modules 102B in the rear row 202 of wavelets 104 also at the first height h₁.

The fin assembly 400A may include a fin 402 and a riser 404. The fin 402 includes base flanges 406 and a fin body 408. The base flanges 406 extend laterally or sideways, e.g., in a same direction as dashed reference lines that designate the first height h₁ and the second height h₂. The base flanges 406 may also extend longitudinally a sufficient distance to have formed therein threaded through holes (not labeled) that may engage with screws or bolts 410 to secure the fin 402 to a rail. The fin body 408 extends upward from the base flanges 406.

As illustrated in FIG. 4A, the riser 404 includes two elongate bars 404A, 404B that straddle the fin body 408. In other embodiments, the riser 404 may include a single elongate bar with a fork at one end to straddle the fin body 408, or a single elongate bar without a fork and positioned to one side or the other of the fin body 408. The riser 404 may include any other suitable configuration.

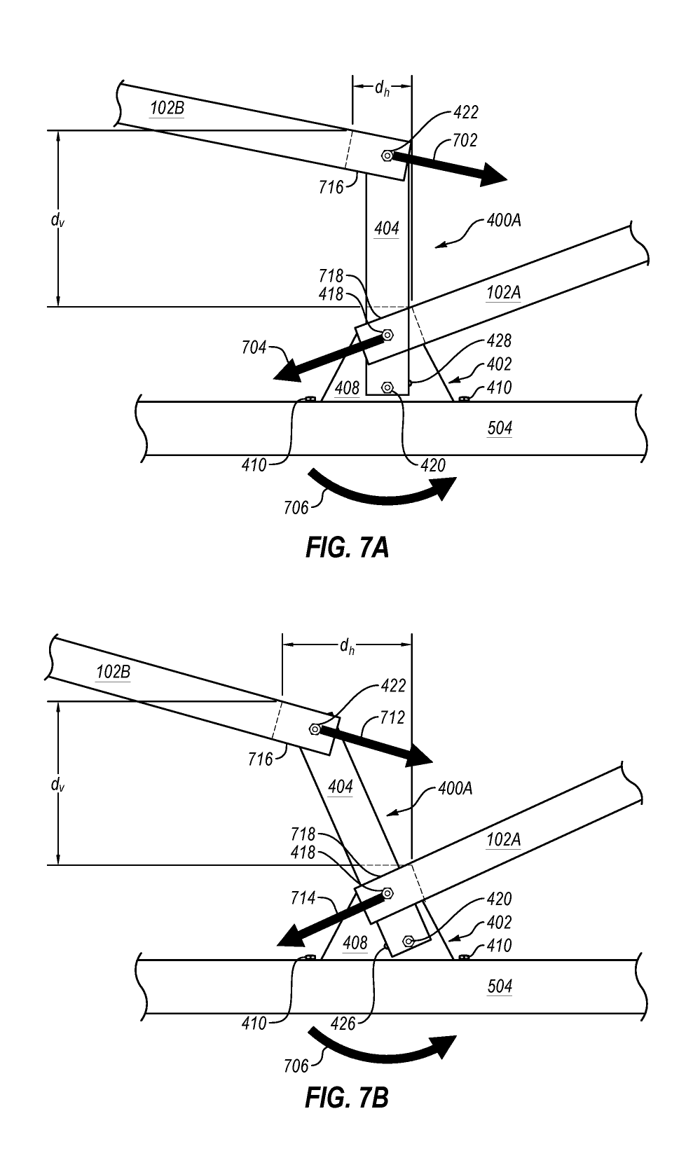

The riser 404 has a first location 412, a second location 414, and a third location 416 that are vertically offset from each other. The first, second, and third locations 412, 414, and 416 may be aligned along the length of the riser 404 in some embodiments. In these and other embodiments, the riser 404 may be arranged vertically and coupled to the fin 402 (as in FIG. 7A) to achieve the configuration 200A of FIG. 2A in which there is little or no horizontal offset between lower edges of adjacent front and rear PV modules 102A and 102B. Alternatively, the riser 404 may be tilted forward and coupled to the fin 402 (as in FIG. 7B) so that the first, second, and third locations 412, 414, and 416 are horizontally offset from each other to achieve the configuration 200B of FIG. 2B in which there is a relatively larger horizontal offset between lower edges of adjacent front and rear PV modules 102A and 102B than in FIG. 2A.

The riser 404 may be mechanically coupled to the fin body 408 at the first and second locations 412 and 414. For instance, through holes (not visible) may be formed in both the riser 404 and the fin body 408 at each of the first location 412 and the second location 414 to receive therethrough at least a portion of a fastener 418, 420 that mechanically couples the fin body 408 and the riser 404 together. One or more through holes (not visible) may also be formed in the riser 404 at the third location 416 to receive therethrough at least a portion of a fastener 422. Each of the fasteners 418, 420, 422 may include both a bolt that passes through the corresponding through hole(s) and a nut that engages an end of the bolt and prevents the bolt from being removed until the nut is removed. Alternatively or additionally, each of the fasteners may include both a clevis pin that passes through the corresponding through hole(s) and a cotter pin that engages an end of the clevis pin and prevents the clevis pin from being removed until the cotter pin is removed.

In addition, the first location 412 of the riser 404 may be at the first height h₁ and the third location 416 of the riser 404 may be at the second height h₂ when the riser 404 is mechanically coupled to the fin 402 and the fin 402 is mechanically coupled to a rail 106. In these and other embodiments, adjacent lower corners of adjacent front PV modules 102A may each be mechanically coupled one on each side to the riser 404 at the first location 412 and first height h₁, e.g., using the fastener 418. Adjacent lower corners of adjacent rear PV modules 102B may each be mechanically coupled one on each side to the riser 404 at the third location 416 and second height h₂, e.g., using the fastener 422.

Thus, up to four PV modules 102 (two front PV modules 102A and two rear PV modules 102B) may be coupled to a single fin assembly 400A within an interior of an asymmetric wave PV system. However, where the fin assembly 400A is used along an edge (front, rear, or side) of an asymmetric wave PV system, only two PV modules 102 per fin assembly 400A may be coupled to each fin assembly 400A.

The fin assembly 400B may include the same fin 402, screws or bolts 410, and fasteners 418, 420 as the fin assembly 400A. Instead of the riser 404, the fin assembly 400B includes a stub riser 424. The stub riser 424 has the same first location 412 and second location 414 as the riser 404 and is similarly coupled to the fin body 408 of the fin 402 at the first location 412 using the fastener 418 and at the second location 414 using the fastener 420. In these and other embodiments, a single lower corner or adjacent lower corners of a single front PV module 102A (or single rear PV module 102B in the rear row 202 of FIGS. 2A and 2B) or of adjacent front PV modules 102A (or of adjacent rear PV modules 102B in the rear row 202 of FIGS. 2A and 2B) may each be mechanically coupled one per side to the stub riser 424 at the first location 412 and first height h₁, e.g., using the fastener 418.

Thus, up to two PV modules 102 (two front PV modules 102A or two rear PV modules 102B) may be coupled to a single fin assembly 400B along an edge of an asymmetric wave PV system. However, a single PV module 102 per fin assembly 400B may be coupled to each fin assembly 400A at each of the four corners of the asymmetric wave PV system.

Each of the fin assemblies 400A and 400B may optionally further include one or more washers, star washers, spacers, and/or other elements than are illustrated in FIG. 4A. Alternatively or additionally one or more of the elements that make up the fin assemblies 400A and 400B may be integrated together. For instance, the fin 402 and the riser 404 (or the fin 402 and the stub riser 424) may be integrally formed together as a single part. Alternatively or additionally, the elongate bars 404A, 404B that make up the riser 404 and the spacer 430 may be replaced with a single extruded component, such as an elongate extruded box.

FIG. 4B is an exploded perspective view of the fin assembly 400A of FIG. 4A, arranged in accordance with at least one embodiment described herein. As illustrated in FIG. 4B, each of the elongate bars 404A and 404B of the riser 400 includes a corresponding through hole formed therethrough at each of the first, second, and third locations 412, 414, and 416. One or more of the through holes may be tapped and/or one or of the through holes may be smooth.

FIG. 4B additionally illustrates two through holes 426 and 428 that may be formed in the fin body 408 of the fin 402. Each of the two through holes 426 and 428 may be configured to receive therethrough a portion of the fastener 420. When the fastener 420 is inserted through the through hole 426 to couple the riser 404 to the fin 402, the riser 404 may be arranged vertically relative to the fin 402 (see FIG. 7A) to achieve the configuration 200A of FIG. 2A. On the other hand, when the fastener 420 is inserted through the through hole 428 to couple the riser 404 to the fin 402, the riser 404 may be tilted forward relative to the fin 402 (see FIG. 7B) to achieve the configuration 200B of FIG. 2B.

FIG. 4B additionally illustrates an example implementation of each of the fasteners 418, 420, and 422. In the example of FIG. 4B, the fastener 418 includes a double-ended bolt 418A with no head with threaded ends extending in opposite directions from the fin body 408, a first nut (optionally with a star washer) 418B, and a second nut (optionally with a star washer) 418C. In the example of FIG. 4B, the fastener 420 includes a bolt 420A and a nut (optionally with a star washer) 420B. In the example of FIG. 4B, the fastener 422 includes a double-ended bolt 422A with no head with threaded ends extending in opposite directions, a first nut (optionally with a star washer) 422B, and a second nut (optionally with a star washer) 422C.

The fin assembly 400A may further include a spacer 430 with a width that may be equal to the width of the fin body 408. The spacer 430 may receive therethrough the double-ended bolt 422A of the fastener 422 and may be located between third locations 416 of each of the elongate bars 404A and 404B of the riser 404 to keep the elongate bars 404A and 404B spaced apart from each other at the third locations 416. In this and other embodiments, a spacing between adjacent bottom corners of adjacent PV modules may be equal or substantially equal to a sum of a thickness of the spacer 430, a thickness of the elongate bar 404A, and a thickness of the elongate bar 404B. In other embodiments that include, e.g., an elongate extruded box instead of the elongate bars 404A and 404B and the spacer 430, the spacing between adjacent bottom corners of adjacent PV modules may be equal or substantially equal to a thickness of the elongate extruded box. In such embodiments, cutouts may be formed at the bottom of the elongate extruded box in a middle of two opposing walls of the elongate extruded box to straddle the fin 402 with the elongate extruded box.

FIG. 4B further illustrates example grounding paths 432 through the fin assembly 400A. Some or all of the components of the fin assembly 400A may include one or more electrically conductive materials, such as metal including aluminum, steel, metal alloy, or other suitable electrically conductive materials.

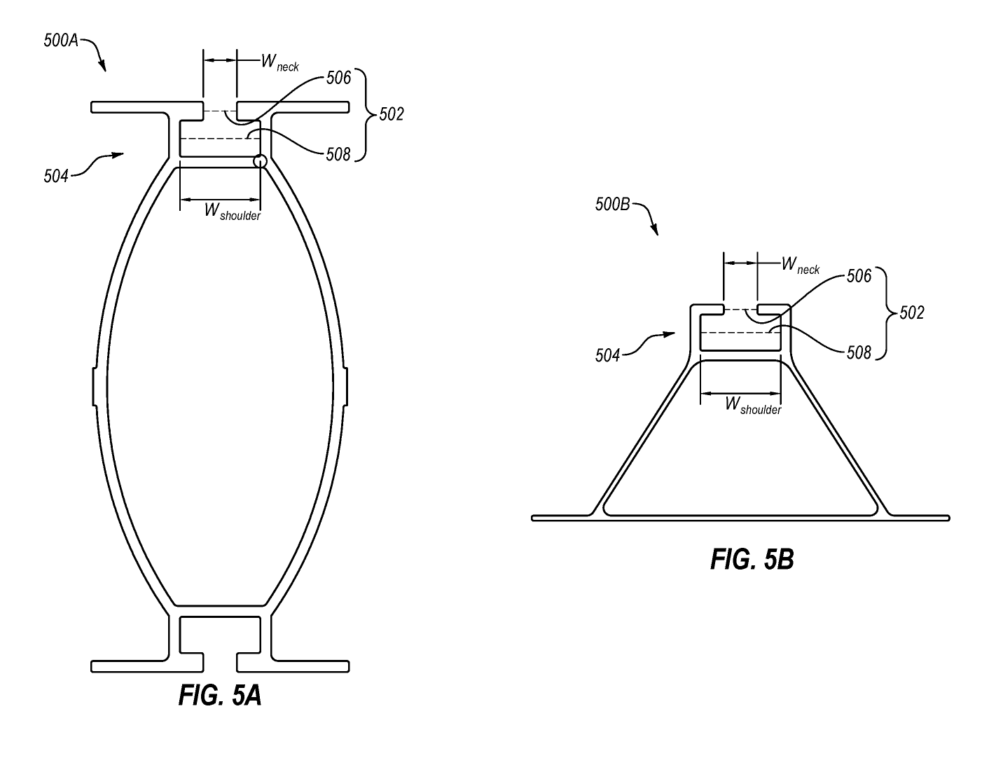

FIGS. 5A and 5B is each an end view of an example rail 500A or 500B (generically hereafter “rail 500” or “rails 500”) that may be implemented in one or more asymmetric wave PV systems, arranged in accordance with at least one embodiment described herein. Each of the rails 106 illustrated in FIGS. 1A-3 may be the same as or similar to at least one of the rails 500 of FIGS. 5A and 5B.

As illustrated in FIGS. 5A and 5B, each of the rails 500 defines an open slot 502 that runs along at least a portion of a top 504 of the rail 500. In an example implementation, the open slot 502 runs a length (in and out of the page in the views of FIGS. 5A and 5B) of the top 504 of the rail 500. In other implementations, the open slot 502 may be interrupted in one or more locations or spans along the length of the rail 500. In general, the open slot 502 has a cross-sectional shape suitable to retain therein a portion of a corresponding fin assembly 108, 400A, or 400B. In particular, the cross-sectional shape of the open slot 502 as illustrated in FIGS. 5A and 5B includes a neck 506 with neck width w_{neck} and shoulders 508 below the neck 506 that have a shoulder width w_{shoulder} that is greater than the neck width w_{neck}.

The different rails 500 of FIGS. 5A and 5B may be implemented in different types of installations. For instance, rails such as the rail 500A of FIG. 5A may be implemented in one type of installation (e.g., in an asymmetric wave PV system implemented as a carport roof), while rails such as the rail 500B of FIG. 5B may be implemented in another type of installation (e.g., in an asymmetric wave PV system installed on an existing nominally horizontal roof).

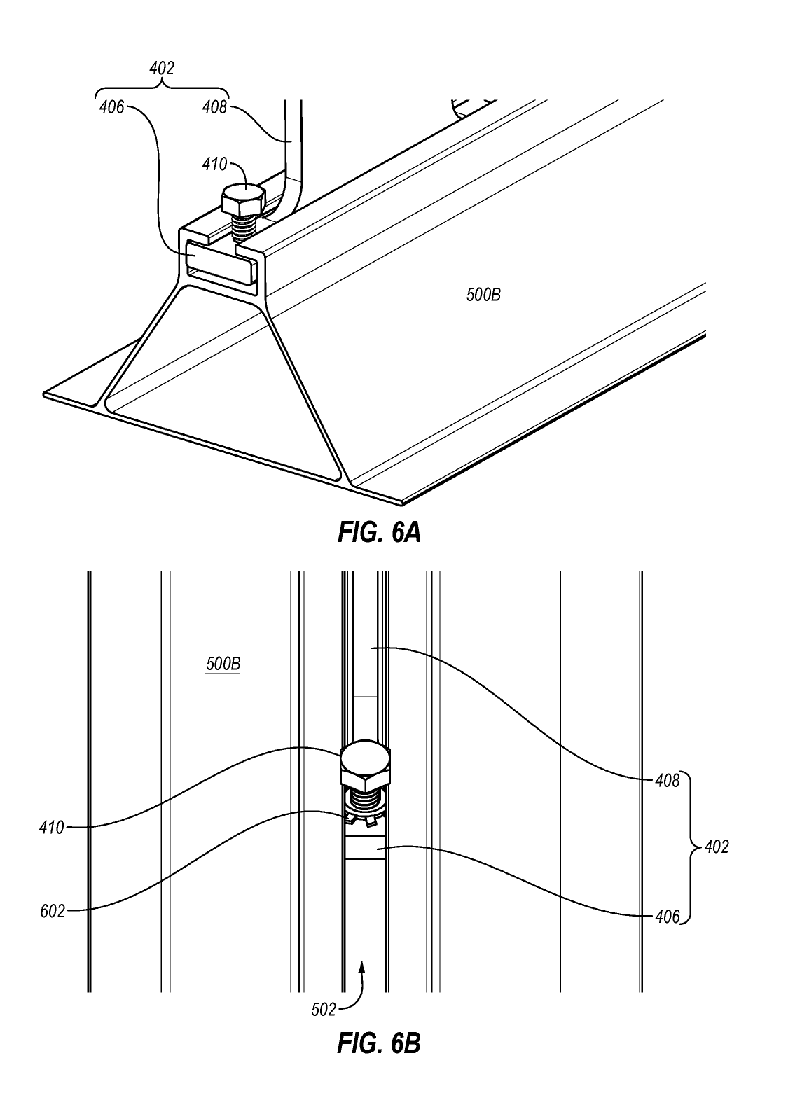

FIGS. 6A and 6B are detail perspective views of one of the fins 402 of FIG. 4A mechanically coupled to the rail 500B of FIG. 5B, arranged in accordance with at least one embodiment described herein. With combined reference to FIGS. 4A-6B, the base flanges 406 of each fin 402 may extend sideways to a width that is greater than or equal to the neck width w_{neck} of the neck 506 of the open slot 502 and less than or equal to the shoulder width w_{shoulder} of the shoulders 508 of the open slot 502. In addition, the fin body 408 of each fin 402 may have a width that is less than the neck width w_{neck} of the neck 506 of the open slot 502. Thus, the width of the base flanges 406 of each fin 402 may be sufficiently small that the base flanges 406 may be received within and accommodated by the shoulders 508 of the open slot 502 of the rail 500 and sufficiently wide that the base flanges 406 interfere and engage with the neck 506 of the open slot 502 of the rail 500 to prevent the fin 402 from being vertically separated from the rail 500 when engaged within the open slot 502. Instead, the fin 402 may be separated from the rail 500 by sliding the fin 402 out one end or the other of the open slot 502.

FIG. 6B further illustrates a star washer 602 that may be included in the fin assemblies 400A, 400B of FIGS. 4A-4B. Each bolt 410 may be received through a corresponding star washer 602. Vertically, the star washer 602 may be located above the base flanges 406 of the fin 402, and below an overhang that defines the neck 506 of the open slot 502. To couple the fin assembly 400A to the rail 500B, the components may arranged relative to each other as illustrated in FIGS. 6A and 6B and the bolt 410 may be tightened such that it drives a bottom end of the bolt 410 into a bottom of the open slot 502, forcing the base flanges 406 of the fin 402 upward into the underside of the overhang that defines the neck 506 of the open slot and locking the fin 402 into place with respect to the rail 500B.

Other fins and rails disclosed herein may be analogously coupled together. Additional details regarding some example rails and/or fins that may be implemented as one or more of the rails and/or fins described herein are provided in U.S. Patent Publication No. 2013/0312812, which is incorporated herein by reference in its entirety.

FIGS. 7A and 7B are detail elevation views of portions of front and rear PV modules 102A and 102B, the fin assembly 400A, and the top 504 of the rail 500B mechanically coupled together, arranged in accordance with at least one embodiment described herein. The components illustrated in FIG. 7A are coupled together according to the configuration 200A of FIG. 2A where lower edges of adjacent front and rear PV modules 102A and 102B have little to no horizontal offset from each other. In comparison, the components illustrated in FIG. 7B are coupled together according to the configuration 200B of FIG. 2B where lower edges of adjacent front and rear PV modules 102A and 102B have a relatively larger horizontal offset.

FIG. 7A additionally illustrates force vectors 702 and 704 of forces respectively exerted by the rear PV module 102B and the front PV module 102A on the fin assembly 400A as well as a moment resistance 706. Because the force vectors 702 and 704 act on the fin assembly 400A at locations that are vertically offset from each other and because the moment arm at the top of the riser 404 due to the force 702 is much longer than the moment arm near the bottom of the riser 404 due to the force 704, there is an imbalanced moment applied to the fin assembly 400A and/or the rail 500B. The magnitude of the imbalanced moment may increase as the peak angle θₚₑₐₖ (FIG. 1A) increases. The imbalanced moment is resisted by the fasteners 418 and 420, the fin 402, and/or the rail 500B, as indicated by the moment resistance 706. The moment resistance may be at least 7500 inch pounds (in-lbs.) or greater.

As described previously, when the fastener 420 is inserted through the through hole 426 (visible only in FIG. 7B) to couple the riser 404 to the fin 402, the riser 404 may be arranged vertically relative to the fin 402 as illustrated in FIG. 7A to achieve the configuration 200A of FIG. 2A. On the other hand, when the fastener 420 is inserted through the through hole 428 (visible only in FIG. 7A) to couple the riser 404 to the fin 402, the riser 404 may be tilted forward relative to the fin 402 as illustrated in FIG. 7B to achieve the configuration 200B of FIG. 2B.

FIG. 7B additionally illustrates force vectors 712 and 714 of forces respectively exerted by the rear PV module 102B and the front PV module 102A on the fin assembly 400A as well as the moment resistance 706. In addition to increasing the horizontal offset compared to the embodiments of FIGS. 2A and 7A, tilting the riser 404 according to the embodiments illustrated in FIGS. 2B and 7B may also reduce a magnitude of the imbalanced moment applied to the fin assembly 400A and/or the rail 500B as compared to the embodiments illustrated in FIGS. 2B and 7B. In particular, tilting the riser 404 forward (and keeping the spacing between adjacent fin assemblies constant) causes both of the front and rear PV modules 102A and 102B to be at steeper front and rear angles θ_{front} and θᵣₑₐᵣ compared to in FIGS. 2A and 7A. Because the front and rear PV modules 102A and 102B are at steeper angles, the horizontal components of the force vectors 712 and 714 in FIG. 7B are less than the horizontal components of the force vectors 702 and 704 in FIG. 7A, thereby reducing the moments generated by the force vectors 712 and 714 as compared to the moments generated by the force vectors 702 and 704. In addition, because the riser 404 is tilted forward, the vertical component of the force vector 712 generates a moment that is opposite to and at least partially cancels out the moment generated by the horizontal component of the force vector 712.

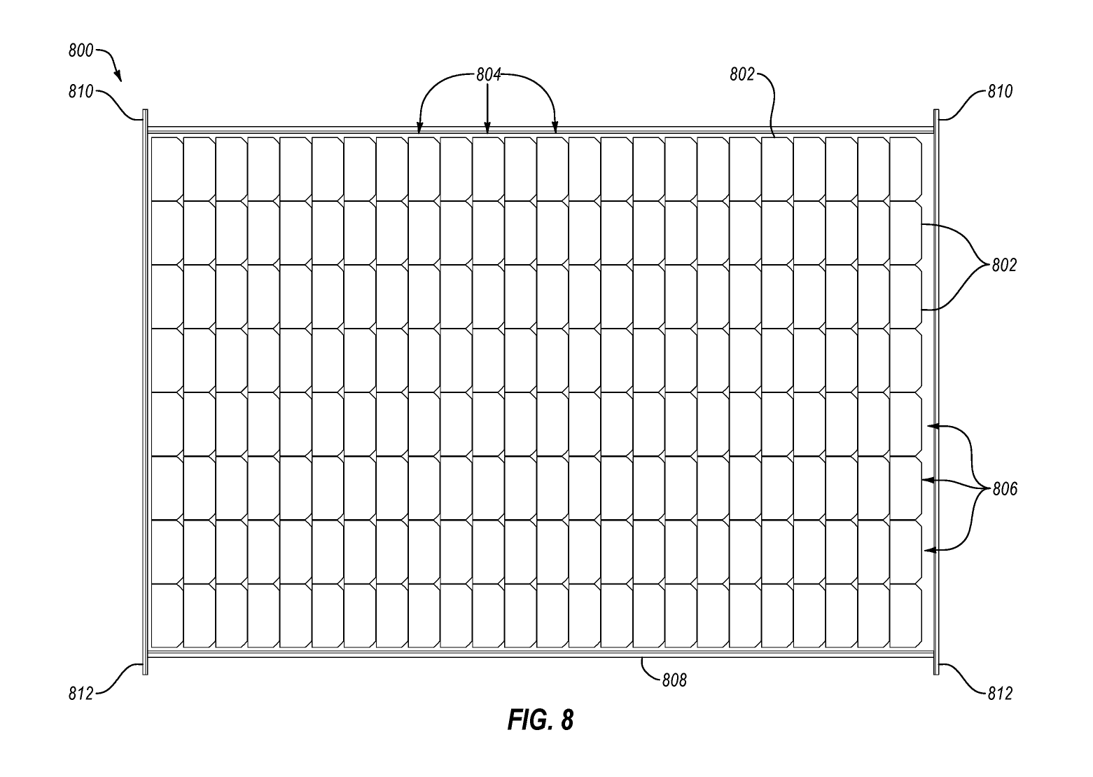

As described in more detail with respect to FIG. 8A, each of the front and rear PV modules 102A and 102B may have frame extensions at each of four corners of the front and rear PV modules 102A and 102B. FIGS. 7A and 7B illustrate one lower frame extension 716 at one of two lower corners of the rear PV module 102B and one lower frame extension 718 at one of two lower corners of the front PV module 102A.

As illustrated in FIG. 7A, and if the lower frame extensions 716 and 718 are ignored, a horizontal offset dₕ between a lower edge of the front PV module 102A and a lower edge of the rear PV module 102B may be relatively small. FIG. 7A also illustrates a vertical offset dᵥ between the lower edge of the front PV module 102A and the lower edge of the rear PV module 102B.

In FIG. 7B, because the riser 404 is tilted forward, the horizontal offset dₕ between the lower edge of the front PV module 102A and the lower edge of the rear PV module 102B may be larger than in FIG. 7A. The horizontal offset dₕ in embodiments in which the riser 404 is tilted forward may be at least 50 millimeters (mm) and/or may be in a range from 50 mm to 150 mm. Also in FIG. 7B, the vertical offset dᵥ between the lower edge of the front PV module 102A and the lower edge of the rear PV module 102B may be less than in FIG. 7A due to the forward tilt of the riser 404 in FIG. 7B. The vertical offset dᵥ in FIG. 7A and in FIG. 7B may be in a range from 100 millimeters mm to 300 mm in some embodiments.

In FIG. 7B, the combination of the horizontal offset dₕ and the vertical offset dᵥ may present a large enough gap between the adjacent front and rear PV modules 102A and 102B illustrated in FIG. 7B for a person to walk between the front and rear PV modules 102A and 102B, placing each foot through the gap onto an underlying installation surface. This gap that can accommodate foot traffic may in some cases be referred to as a “hidden walkway”, the walkway being hidden in the sense that it may see little or no direct sunlight if implemented in an asymmetric array PV system in which the front PV modules 102A are arranged to face south and/or west in installations in the Northern Hemisphere as described elsewhere. In some embodiments, the person may partially lean on or otherwise partially support the person's weight on the front PV module 102A as the person walks between the front and rear PV modules 102A and 102B using the hidden walkway.

FIG. 8 is an overhead view of an example PV module 800 that may be implemented in one or more asymmetric wave PV systems, arranged in accordance with at least one embodiment described herein. Each of the PV modules 102 described elsewhere herein may include a PV module such as the PV module 800 of FIG. 8.

In the illustrated embodiment, the PV module 800 includes multiple PV cells 802 arranged in an array of cell rows 804 and cell columns 806. Only some of the PV cells 802, cell rows 804, and cell columns 806 are labeled in FIG. 8 for simplicity. The PV cells 802 within each cell row 804 may be electrically connected in parallel to each other and the cell rows 804 may be electrically connected in series to each other.

In some embodiments, current generated by the PV cells 802 during operation travels substantially uni-directionally from left to right through the PV cells 802. Further, the parallel electrical connection of the PV cells 802 within each cell row 804 may allow current to re-balance from top to bottom to maximize current flow in the case of non-uniform illumination of the PV cells 802. Additional details regarding current balancing that may be implemented in one or more of the embodiments of the instant application are disclosed in more detail in U.S. Pat. No. 8,748,727 and U.S. Pat. No. 8,933,320, both of which are incorporated herein by reference.

Due to the above-described configuration of the PV cells 802, the PV module 800 may be relatively insensitive to non-uniform illumination conditions as compared to some conventional PV modules that implement only serially-connected PV cells. The insensitivity of the PV module 800 to non-uniform illumination conditions may allow the PV modules 800 to be used in asymmetric wave PV systems such as illustrated in FIGS. 1B-2B despite some shading of portions of some of the front PV modules 102A by the rear PV modules 102B for some angles of incident illumination.

As further illustrated in FIG. 8, the PV module 800 includes a frame 808 with two upper frame extensions 810 at two upper corners of the PV module 800 and two lower frame extensions 812 at two lower corners of the PV module 800. The lower frame extensions 812 are examples of the lower frame extensions 716 and 718 of FIGS. 7A and 7B. The upper and lower frame extensions 810 and 812 may be coplanar with the rest of the frame 808 and/or the PV module 800. In particular, top surfaces (e.g., surfaces generally facing upward when the PV module 800 is installed in a system) of the upper and lower frame extensions 810 and 812 may be coplanar with a top surface of the rest of the frame 808 and/or with a top surface of the PV module 800.

Each of the two upper frame extensions 810 at the two upper corners of the PV module 800 may be coupled to a corresponding one of two upper frame extensions 810 at two upper corners of another PV module 800 to form a peak of a wavelet that includes the two PV modules 800. Each of the two lower frame extensions 812 at the two lower corners of the PV module 800 may be coupled to a corresponding rail or rails through a corresponding fin assembly as described elsewhere herein.

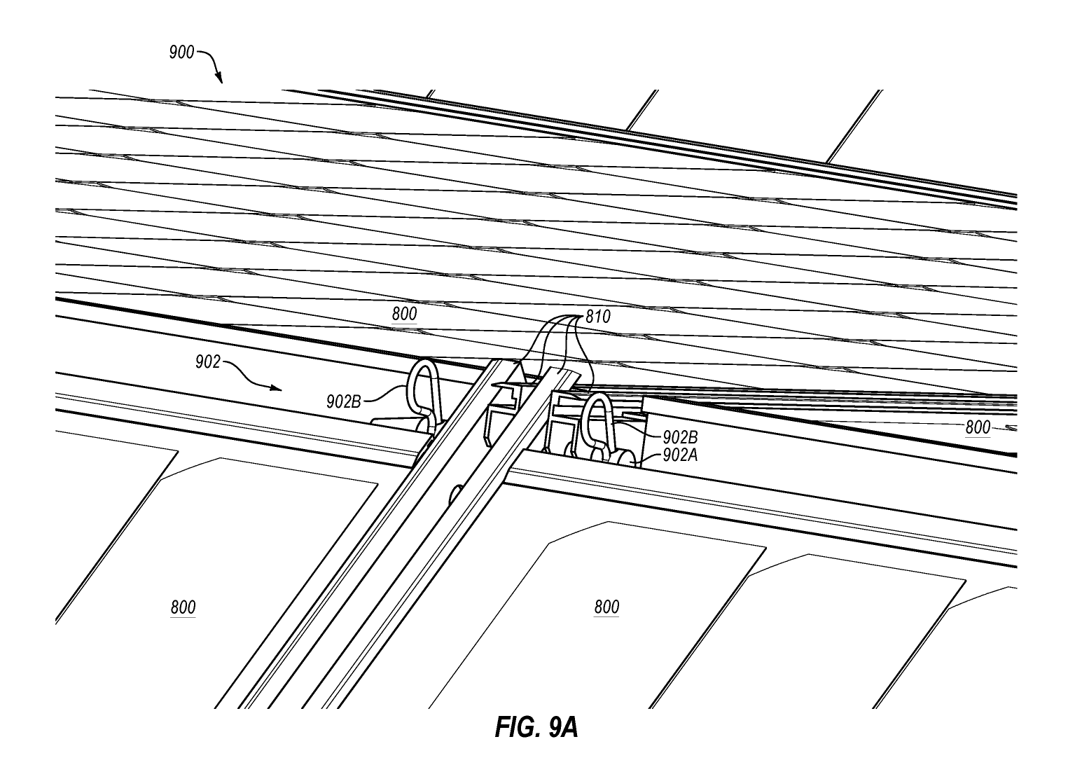

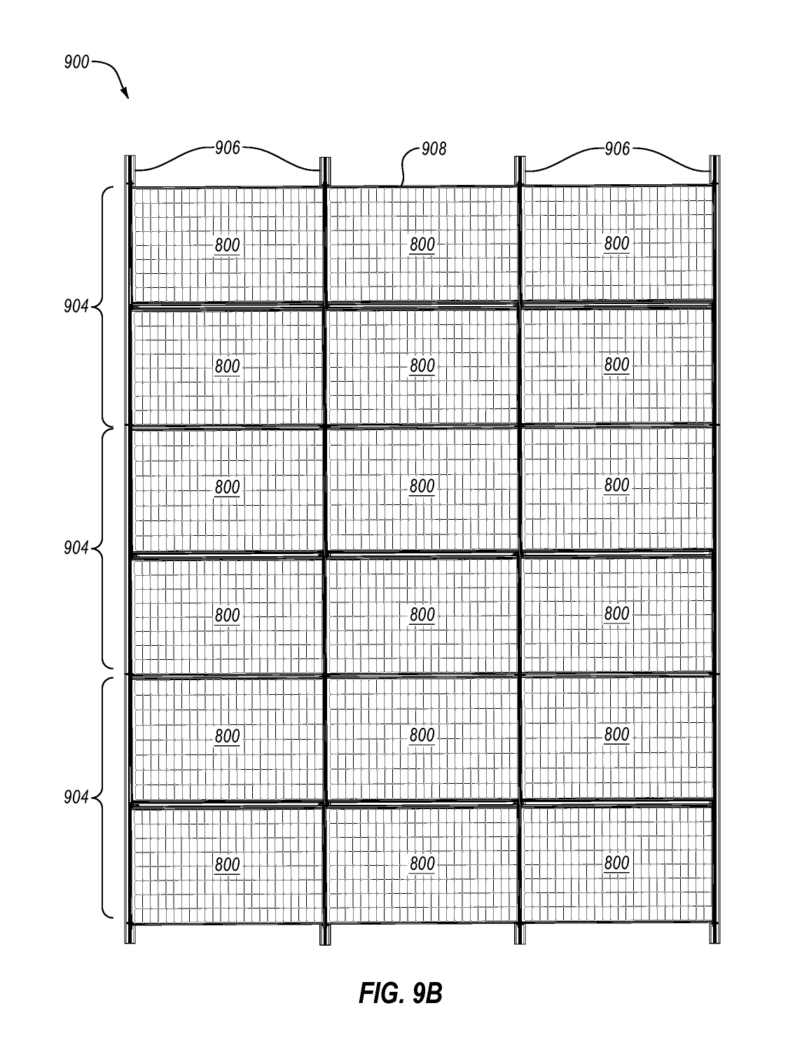

FIG. 9A is an overhead detail view of a portion of another asymmetric wave PV system 900 (hereinafter “system 900”), arranged in accordance with at least one embodiment described herein. The system 900 may include or correspond to the system 100B described elsewhere herein. FIG. 9A illustrates four of the PV modules 800 of FIG. 8A included as part of the system 900.

The four PV modules 800 illustrated in FIG. 9A are arranged as two wavelets in a row of wavelets. Thus, the upper frame extension 810 at the upper corner of the leftmost PV module 800 in the foreground of FIG. 9A is coupled to the upper frame extension 810 at the upper corner of the leftmost PV module 800 in the background of FIG. 9A. Similarly, the upper frame extension 810 at the upper corner of the rightmost PV module 800 in the foreground of FIG. 9A is coupled to the upper frame extension 810 at the upper corner of the rightmost PV module 800 in the background of FIG. 9A. In these and other embodiments, one or more fasteners 902 may be provided to couple together two or more upper frame extensions 810. In particular, in FIG. 9A, the one or more fasteners 902 include one or more clevis pins 902A that pass through holes formed in the upper frame extensions 810 and one or more cotter pins 902B that engage the one or more clevis pins 902A and prevent the one or more clevis pins 902A from being removed from the upper frame extensions 902A until the one or more cotter pins 902B are removed.

As illustrated in FIG. 9A, when coupled together, the frame extensions 810 are offset from each other in a direction parallel to a length of the clevis pin 814A, e.g., in the direction running along the peak of the two illustrated wavelets. The offset that results from coupling PV modules 800 together at their upper corners as illustrated in FIG. 9A may introduce skew when the PV modules 800 are used to form the array 900.

FIG. 9B is an overhead view of the system 900 of FIG. 9A, arranged in accordance with at least one embodiment described herein. As illustrated, the system 900 includes three rows 904 of three wavelets each, where each wavelet includes two PV modules 800, similar to the wavelets 104 described above. The PV modules 800 are coupled to rails 906 through fin assemblies (not visible). The rails 906 may include or correspond to the rails 106 described above. Only some of the rails 906 are labeled in FIG. 9B for simplicity.

Due to the skew introduced into the system 900 as described with respect to FIG. 9A, each successive line of rails 906 may shift forward relative to a preceding line of rails 906 by a relatively small distance, which may be about 0.5-1.5% of the length of the PV modules 800. For instance, if each PV module 800 has dimensions of 2 meters (m) in length by 1.3 m in width, each successive line of rails 906 may shift forward by about 0.01 m (0.394 inches) to 0.03 m (1.18 inches). Alternatively, the shift may be more or less than the state range. For instance, counting from left to right in FIG. 9B, the second line of rails 906 may be shifted forward relative to the first line of rails 906 by about 0.375 inches; the third line of rails 906 may be shifted forward relative to the second line of rails 906 by another 0.375 inches (or by 2×0.375=0.75 inches relative to the first line of rails 906); and the fourth line of rails 906 may be shifted forward relative to the third line of rails 906 by about 0.375 inches (or by 3×0.375=1.125 inches relative to the first line of rails 906).

The forward shift of each successive line of rails 906 causes a perimeter 908 of the wavelets in aggregate and as projected downward onto a horizontal reference plane to generally have a rhomboid shape (quadrilateral with opposite sides being parallel, adjacent sides being unequal in length, and angles not being right angles) or a rhombus shape (quadrilateral with opposite sides being parallel, all sides being equal in length, and angles not being right angles).

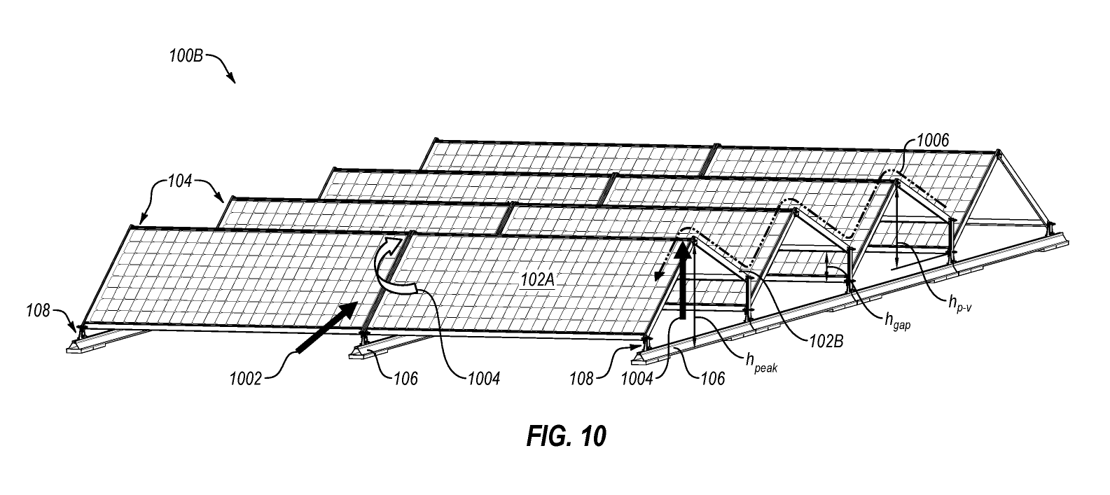

FIG. 10 is a perspective view of the system 100B of FIG. 1B with various example parameters, arranged in accordance with at least one embodiment described herein. The values of the various parameters may be selected to, e.g., limit wind shearing forces and snow drifting, increase cleaning during rainfall, minimize or at least reduce snow accumulation, maximize or at least increase backside cooling and provide a gap for snow to slide off the PV modules 102 while avoiding or at least reducing pressurization from the gap, and/or resist wind uplift along edges of the system 100B.

The parameters of the system 100B may include a peak height hₚₑₐₖ, a gap height h_{gap}, and a peak-to-valley height hₚ₋ᵥ. Each will be discussed in turn.

The peak height hₚₑₐₖ is defined as a height of the peaks of the asymmetric wavelets 104, e.g., the vertical distance from a bottom of the rails 106 or a bottom of the pads 110 to the peaks of the asymmetric wavelets 104. In an example embodiment, the peak height hₚₑₐₖ may be less than 0.75 m, at least in embodiments in which the PV modules 102 are 2 m long by 1.3 m wide. Compared to systems with peak height hₚₑₐₖ greater than 0.75 m, embodiments described herein may minimize or at least reduce wind shear forces, denoted at 1002 in FIG. 10, on the system 100B and/or may minimize or at least reduce snow drifting (e.g., accumulation of snow on sheltered sides of the system 100B and/or the wavelets 104).

The gap height h_{gap} is defined as a height of the gap between adjacent front and rear PV modules 102A and 102B in adjacent wavelets 104. The gap height h_{gap} may be approximately equal to the vertical offset dᵥ discussed with respect to FIGS. 7A and 7B, which in turn may be equal to the vertical offset between the first and second heights h₁ and h₂ (FIG. 4A) at which lower corners of the front and rear PV modules 102A and 102B are coupled whether the riser 404 is arranged vertically (e.g., FIG. 7A) or tilted (e.g., FIG. 7B). The equivalence between the gap height h_{gap} and the vertical offset dᵥ is approximate because the PV modules 102 each have a thickness and the gap height h_{gap} is a measure of the vertical distance between a bottom surface of the rear PV module 102B at its lower edge and a top surface of the adjacent front PV module 102A at its lower edge, whereas the vertical offset dᵥ as defined in FIGS. 7A and 7B is a measure of the vertical distance between a top surface of the rear PV module 102B at its lower edge and the top surface of the adjacent front PV module 102A at its lower edge.

In an example embodiment, the gap height h_{gap}, the vertical offset dᵥ, and/or the vertical offset between the first and second heights h₁ and h₂ may be in a range of 100 mm to 300 mm. Keeping the gap height h_{gap} in the range of 100 mm to 300 mm may balance cooling against wind entry. For instance, wind entry may be relatively less at 100 mm than at 300 mm to keep pressurization beneath the system 100B to a minimum or at least reduced compared to systems where the gap height h_{gap} is greater than 300 mm, whereas convective cooling of the backsides of the PV modules 102 may be relatively greater at 300 mm than at 100 mm to operate the PV modules 102 more efficiently than in systems where the gap height h_{gap} is less than 100 mm.

The gap height h_{gap} of the gaps beneath lower edges of the rear PV modules 102B may provide for a relatively high amount of pressure venting within the system 100B. The pressure venting may in turn decrease a pressure differential from top to bottom of the system 100B that may be created by differences in wind velocity across the top and bottom of the system 100B without increasing stagnation forces by having the gaps in the valleys between wavelets 104. Momentum of any wind, denoted at 1006, that flows over the system 100B from rear to front of the system 100B may prevent some or all of the wind 1006 from entering space beneath the system 100B through the gaps. As a result of the foregoing, the system 100B may require less interior ballast, and in some cases no interior ballast, compared to systems that lack such gaps or that have gaps with gap height h_{gap} greater than 300 mm or less than 100 mm.

The gaps beneath lower edges of the rear PV modules 102B may also provide an outlet for any snow that has accumulated on the PV modules 102 to slide off the PV modules 102 through the gaps onto the installation surface. Without the gaps, accumulated snow may remain on some or all of the PV modules 102 for a longer amount of time than with the gaps. For instance, without the gaps or with relatively small gaps, accumulated snow may remain on some or all of the PV modules 102 until it melts, whereas with the relatively large gaps as disclosed herein, accumulated snow can slide off some or all PV modules 102 without having to melt.

The peak-to-valley height hₚ₋ᵥ is defined as a vertical distance between a peak and a valley of each of the wavelets 104. The valley of each wavelet 104 is at the low point of the wavelet, which in the case of an asymmetric wavelet is at the lower edge of the front PV module 102A as described herein. In an example embodiment, the peak-to-valley height hₚ₋ᵥ is greater than 0.5 m. Compared to systems with peak-to-valley heights hₚ₋ᵥ less than 0.5 m, embodiments described herein may minimize or at least reduce wind lift forces, denoted at 1004 in FIG. 10, on wavelets 104 along the edges of the system 100B.

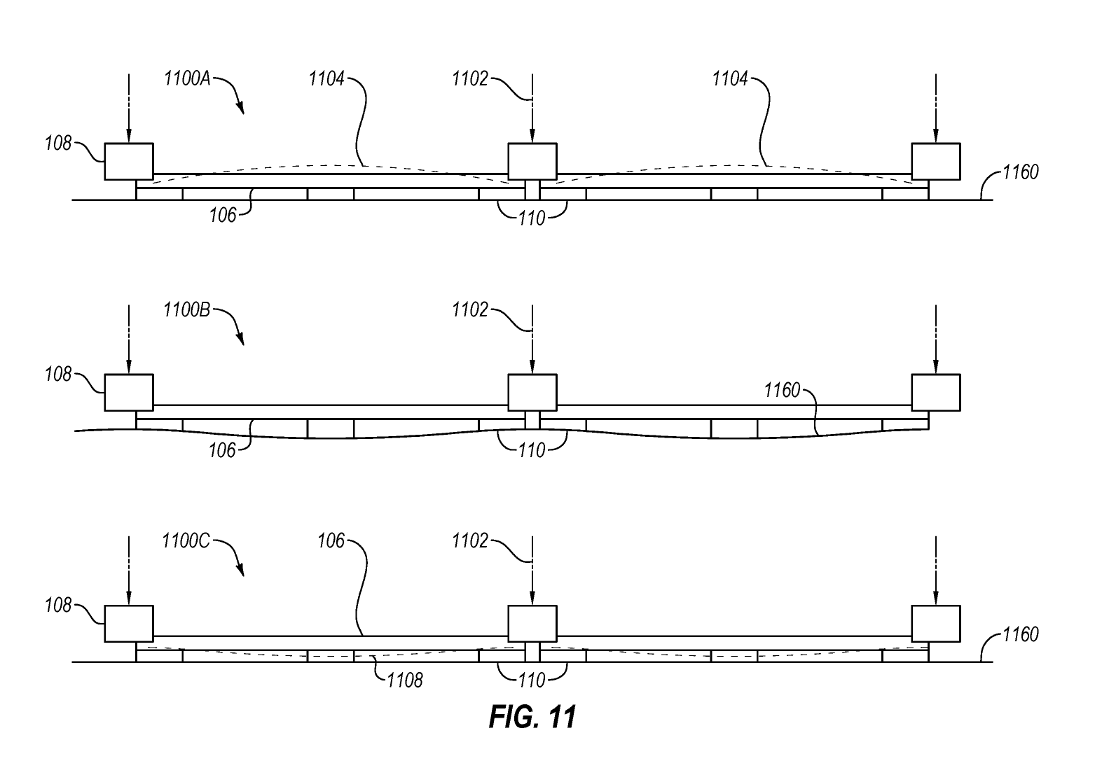

FIG. 11 includes a side view 1100A of a portion of the system 100B of FIG. 1B, arranged in accordance with at least one embodiment described herein. In particular, the side view 1100A includes two rails 106, three fin assemblies 108, and six pads 110. Only some of the rails 106, fin assemblies 108, and pads 110 are labeled in FIG. 11 for simplicity.

In the side view 1100A, the pads 110 are all of the same thickness.

The fin assemblies 108 are loaded, as denoted by arrows 1102 (only one of which is labeled), by the weight of the PV modules 102, which have been omitted from FIG. 11. While the rails 106 are generally stiff, they are not infinitely stiff. Thus, the fin loading 1102 may cause the rails 106 to flex downward, as denoted at 1104, at the ends of the rails 106 where the fin loading 1102 is concentrated. As a result, the weight of the system 100B may be concentrated at locations of an installation surface 1106 beneath the fin assemblies 108. Two embodiments to better distribute the weight of the system 100B on the installation surface 1106 are illustrated in side views 1100B and 1100C of FIG. 11.

In the embodiment illustrated in the side view 1100B, pads 110 with two different thickness are used. In particular, the pads 110 beneath the fin assemblies 108 at the ends of the rails 106 have a first thickness and the pads 110 in between the fin assemblies 108, e.g., beneath the middle of each rail 106, have a second thickness that is greater than the first thickness. The pads 110 beneath the middle of each rail 106 may be referred to as “middle pads 110” while the pads 110 beneath the end of each rail 106 and each fin assembly 108 may be referred to as “end pads 110.” For some installation surfaces 1106, such as some decking materials on trusses, the installation surface 1106 may deflect downward beneath the relatively thicker middle pads 110 to accommodate their greater thickness. Compared to the embodiment illustrated in the side view 1100A, the increased thickness of the middle pads 110 in the embodiment of the side view 1100B reduces pressure at locations of the installation surface beneath the end pads 110 (e.g., under the fin assemblies 108) and increases the pressure at locations of the installation surface 1106 beneath the middle pads 110 (e.g., under the middle of each rail 106) to better distribute the weight of the system 100B on the installation surface 1106.

In the embodiment illustrated in the side view 1100C, each of the rails 106 may be formed crowned, as denoted by a dashed curve 1108, such that at least prior to each rail 106 being coupled through one or more of the fin assemblies 108 to one or more of the wavelets 104, e.g., prior to application of the fin loading 1102, each of the rails 106 has a concave upward curvature. After being coupled through the one or more of the fin assemblies 108 to the wavelets 104, e.g., under application of the fin loading 1102, the rails 106 may flex downward. However, since the rails 106 in the embodiment of the side view 1100C are formed crowned with concave upward curvature, the downward flexion of the rails 106 may flatten out the rails 106 such that under application of the fin loading 1102, the rails 106 are flat or at least flatter than prior to the fin loading 1102. With the rails 106 flattened under application of the fin loading 1102 in the embodiment of the side view 1100C, as opposed to having the concave downward curvature in the side view 1100A, the embodiment of the side view 1100C may better distribute the weight of the system 100B on the installation surface 1106 compared to the embodiment of the side view 1100A.

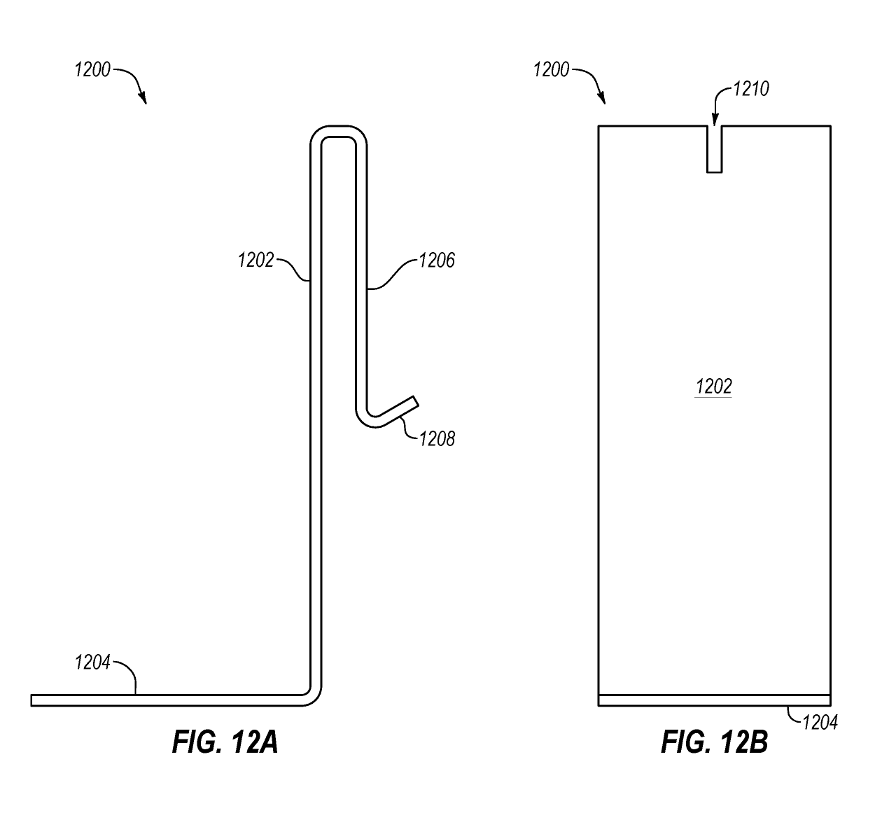

FIGS. 12A and 12B are elevation views of a ballast clip 1200 that may be implemented in one or more of the PV systems described herein, arranged in accordance with at least one embodiment described herein. In particular, FIG. 12A is a side elevation view and FIG. 12B is a front elevation view of the ballast clip 1200. In general, multiple such ballast clips 1200 may be coupled to rails, such as the rails 106, 500, to support ballast to stabilize the corresponding system against, e.g., wind loads. For instance, multiple such ballast clips 1200 may be coupled to rails 106 along opposing perimeter edges of the system 100B to support ballast along the opposing perimeter edges of the system 100B.

As illustrated in FIGS. 12A and 12B, the ballast clip 1200 includes a clip body 1202, a clip foot 1204, a clip arm 1206, and a clip hand 1208. The clip foot 1204 is positioned at one end of the clip body 1202 and extends normal to the clip body 1202. The clip arm 1206 is at an opposite end of the clip body 1202 and extends parallel to the clip body 1202. The clip hand 1208 extends away from an end of the clip arm 1206.

The clip hand 1208 may be configured to be received within an open slot of a corresponding rail, such as within the open slot 502 of the rails 500, to couple the ballast clip 1200 to the corresponding rail.

The ballast clip 1200 may additionally define a slot 1210 at the end of the clip body 1202 from which the clip arm 1206 extends and/or at the end of the clip arm 1206 that is connected to the clip body 1202. The slot 1210 may be configured to receive therein a portion of a retention clip (described below).

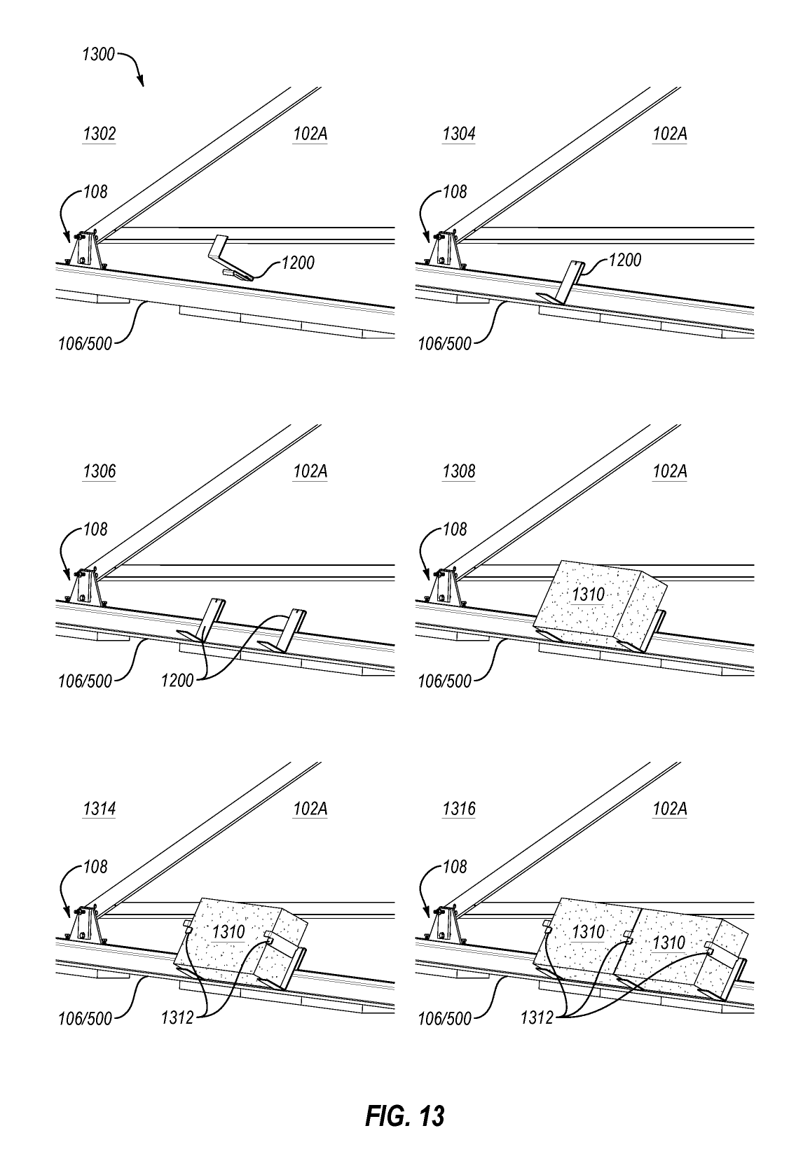

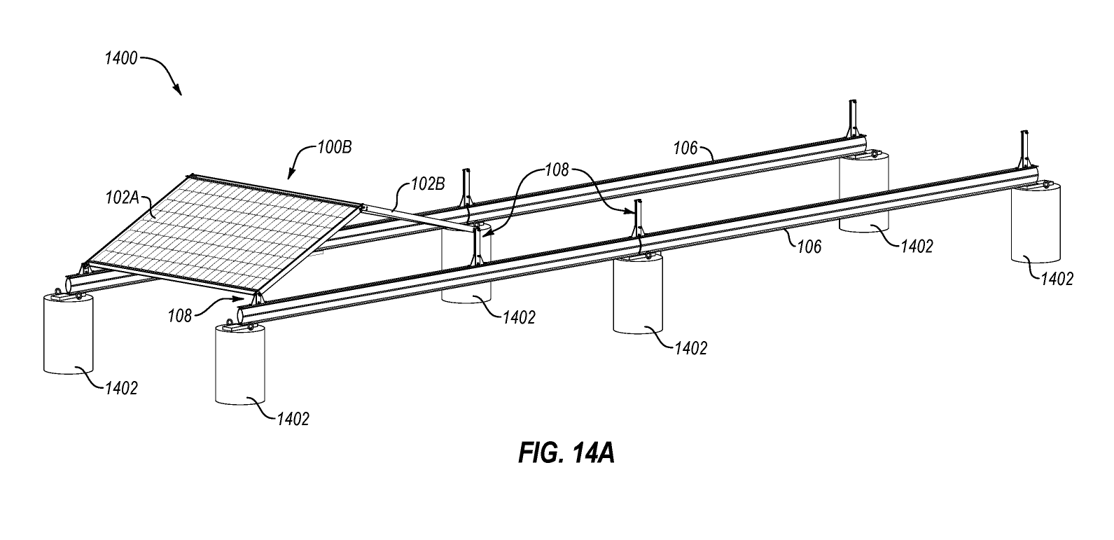

FIG. 13 illustrates an example method 1300 to add ballast to the system 100B, arranged in accordance with at least one embodiment described herein. It is assumed in FIG. 13 that each of the rails 106 in the system 100B is implemented as one of the rails 500 of FIG. 5A or 5B, hence each of the rails 106 is labeled “106/500” in FIG. 13. One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

With combined reference to FIGS. 5A, 5B, and 12A-13, at 1302, the ballast clip 1200 is positioned above the top 504 of the rail 106/500 and rotated and aligned so the clip hand 1208 can be inserted into the open slot 502 of the rail 106/500. With the ballast clip 1200 thus positioned, the clip hand 1208 may be inserted into the open slot 502 under the overhang that defines the neck 506 into one of the two shoulders 508, followed by rotating the ballast clip 1200 down to rest on the rail 106/500 as depicted at 1304. At this point, gravity pulls the ballast clip 1200 down against the rail 106/500 and the clip hand 1208 of the ballast clip 1200 engages the overhang of the rail 106/500 to prevent the ballast clip 1200 from disconnecting from the rail 106/500 unless the ballast clip 1200 is rotated to the orientation illustrated at 1302 and pulled upwards away from the rail 106/500. As illustrated at 1306, the foregoing steps can be repeated as desired to couple any desired number of ballast clips 1200 to the rail 106/500.

At 1308, ballast 1310, e.g., in the form of one or more cinder blocks, is placed on the clip foot 1204 of each of the ballast clips 1200. Each ballast clip 1200 may be coupled to the rail 106/500 at an angle to form a cradle for the ballast 1310. With the ballast 1310 cradled by the ballast clips 1200 as illustrated at 1308 and the ballast clips 1200 supporting the ballast 1310, gravity pulls the ballast 1310 down against the ballast clips 1200 and thus down against the rail 106/500 to stabilize the system 100B.

If significant wind or other forces are expected at an installation location or gravity is otherwise not expected to be sufficient to keep the ballast cradled by the ballast clips 1200, one or more retention clips 1312 may be coupled to the ballast clips 1200 to better retain the ballast 1310 coupled to the ballast clips 1200, as illustrated in FIG. 13 at 1314 and 1316. Each retention clip 1312 may include a hook at one end (not visible) that is inserted into the slot 1210 of the corresponding ballast clip 1200 and one or more tabs (visible but not labeled) at an opposite end from the hook end to retain the ballast 1310 against the corresponding ballast clip 1200. In some embodiments, each retention clip 1312 includes two tabs that extend in opposite directions. The two tabs of the retention clip 1312 can retain adjacent blocks (e.g., two blocks) of ballast 1310 against a single ballast clip 1200 if a gap between the adjacent blocks of ballast 1310 is aligned with the slot 1210 of the ballast clip 1200 so that the retention clip 1312 can be coupled to the ballast clip 1200 and positioned between the adjacent blocks of ballast 1310, e.g., one block on each side of the retention clip 1312.

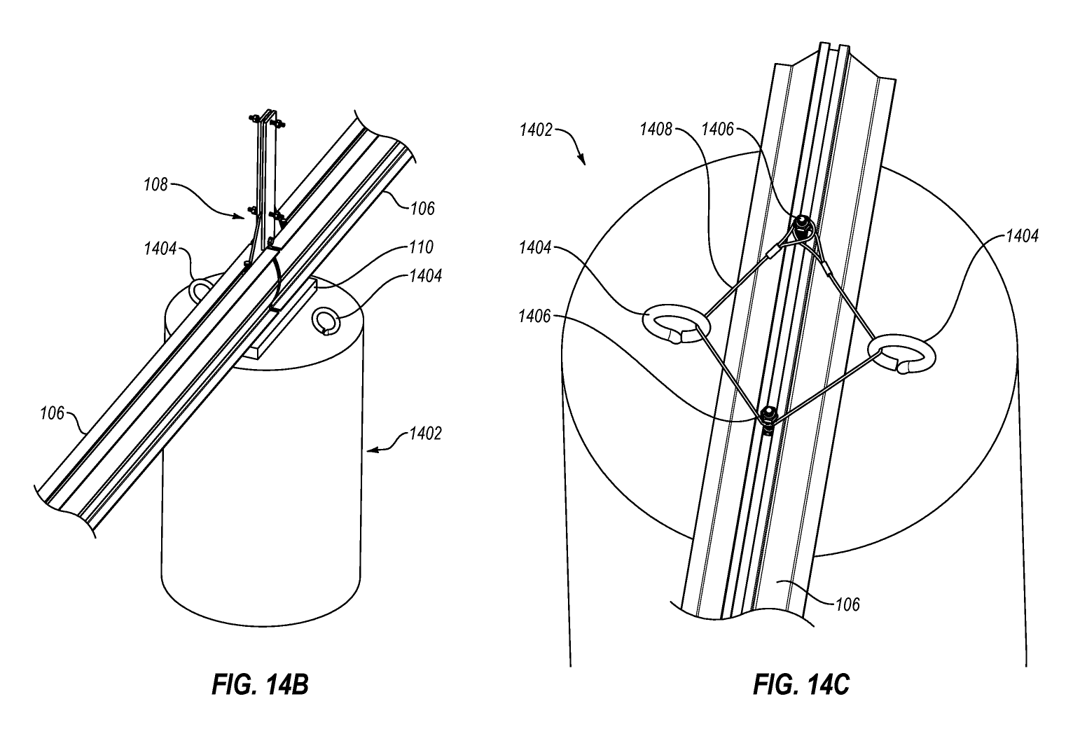

FIG. 14A is a perspective view of a portion of the system 100B in an example ground mount environment 1400 (hereinafter “environment 1400”), arranged in accordance with at least one embodiment described herein. In FIG. 14A, only some of the PV modules 102, wavelets 104, rails 106, and fin assemblies 108 of the system 100B of FIG. 1B are illustrated.

The environment 1400 includes surface footings 1402 that support the system 100B above the ground. In the example of FIG. 14A, the surface footings 1402 include cast-in-place surface footings. In other embodiments, the surface footings 1402 include pre-cast surface footings, such as concrete masonry units, e.g., cinder blocks. The surface footings 1402 may be aligned and spaced apart according to a desired pattern or spacing so that when the system 100B is assembled, there is one surface footing 1402 under every fin assembly 108, under every other fin assembly 108, under every third fin assembly 108, or according to some other pattern or spacing.

In some embodiments, each rail 106 spans each gap between sequential surface footings 1402 so that each end of each rail 106 is supported by a surface footing 1402. In other embodiments, each rail 106 may span an integer multiple of the gaps so that each end of each rail 106 is supported by a corresponding surface footing 1402.

FIG. 14B is a detail perspective view of a portion of FIG. 14A, arranged in accordance with at least one embodiment described herein. As illustrated in FIG. 14B, the pads 110 may be disposed between the surface footings 1402 and the rails 106 supported thereon.

In some embodiments, friction between the system 100B and the surface footings 1402 may be sufficient to retain the system 100B on the surface footings 1402.

In other embodiments, one or more of the surface footings 1402 may include one or more connectors 1404 to couple the system 100B to the surface footings and improve the retention of the system 100B on the surface footings 1402.

FIG. 14C is a detail perspective view of an example connection between one of the surface footings 1402 and one of the rails 106 of FIGS. 14A and 14B, arranged in accordance with at least one embodiment described herein. Some or all of the surface footings 1402 may be coupled to the rails 106 in the same or similar manner as described with respect to FIG. 14C.

In the example of FIG. 14C, each of the connectors 1404 includes an eye bolt with its shaft buried concrete that makes up the surface footing 1402 and its eye extending from a top surface of the surface footing 1402. The rail 106 is positioned on the top surface of the surface footing 1402 between the two connectors 1404. Two nut and bolt fasteners 1406 are coupled to the top of the rail 106. Alternatively, the bolts 410 of the fin assemblies 400A, 400B described above or other fasteners may be used instead of the nut and bolt fasteners 1406.

A compliant cable 1408 together with the connectors 1404 may couple the rail 106 to the surface footing 1402. In the example illustrated, the compliant cable 1408 includes two end loops, one at each end. The two end loops of the compliant cable 1408 are coupled to the top of the rail 106 by the upper nut and bolt fastener 1406. From the right end loop of the compliant cable 1408 at the upper nut and bolt fastener 1406, the compliant cable 1408 extends down to and passes through the right connector 1404 of the surface footing 1402, extends up and passes over the top of the rail 106 where it is coupled to the top of the rail 106 by the lower nut and bolt fastener 1406, extends down and passes through the left connector 1404 of the surface footing 1402, and extends up to terminate back at the upper nut and bolt fastener 1406.

The compliant cable 1408 together with the pad 110 may each be compliant to accommodate freeze and/or thaw ground movements in the surface footing 1402 without causing damage to the rail 106 or other components of the system 100B. The compliant cable 1408 may include stranded metal cable of steel, stainless steel, aluminum or other suitable material(s). The compliant cable 1408 may be from 1/16″ to 3/16″ in diameter in some embodiments.

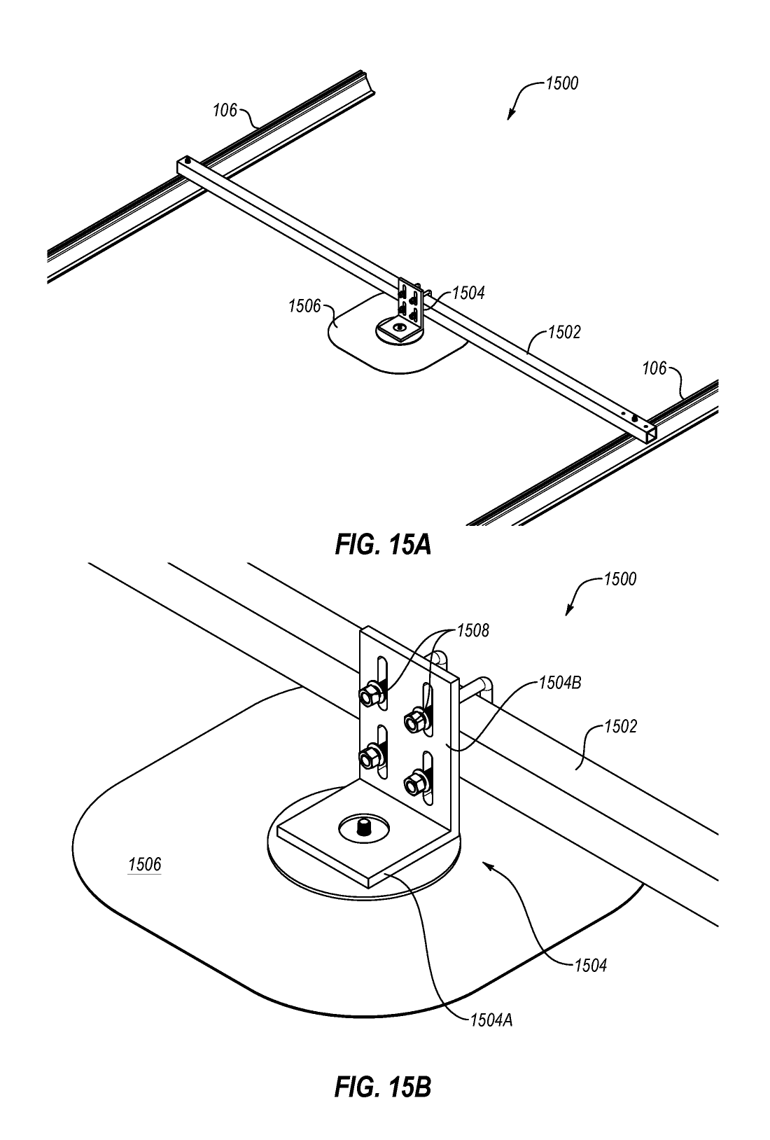

FIG. 15A is a perspective view of a tie-down 1500 that may be implemented in one or more of the PV systems described herein, arranged in accordance with at least one embodiment described herein. FIG. 15B is a detail perspective view of a portion of the tie-down 1500 of FIG. 15A. For instance, the system 100B or other PV systems described herein may include one or more tie-downs 1500 to couple the system 100B to its installation surface. As an example, the arrangement of the tie-down 1500 with respect to two rails 106 of the system 100B is illustrated and described below.

FIG. 15B is a detail perspective view of a portion of the tie-down 1500 of FIG. 15A, arranged in accordance with at least one embodiment described herein. With combined reference to FIGS. 15A and 15B, the tie-down 1500 may include a cross-bar 1502 and an L-b racket 1504.

The cross-bar 1502 may include a 6063 Aluminum square tube 1.75″ by 1.75″ with a 0.125″ wall thickness in an example embodiment, or other material(s) with other dimensions. The cross-bar 1502 has one end coupled to one of the rails 106 and an opposite end coupled to the other one of the rails illustrated in FIG. 15A. The cross-bar 1502 may be coupled to the rails 106 at each of its ends with a fastener, such as a nut and bolt fastener.

The L-bracket 1504 may include aluminum or other suitable material(s). Referring to FIG. 15B, the L-bracket 1504 includes a base 1504A and an upright 1504B. The base 1504A of the L-bracket 1504 may be coupled to an anchor 1506 of the installation surface. The upright 1504B of the L-bracket 1504 may be coupled to the cross-bar 1502. In the example of FIG. 15B, two fasteners 1508 couple the L-bracket 1504 to the cross-bar 1502, where each fastener includes a U-bolt and two nuts.

In some embodiments, to achieve a desired alignment of one or more of the PV systems described herein, such PV systems installed on a building roof may have rails that are aligned perpendicular to joists of the building roof. As such, the rails cross the joists and the load of the PV system may generally be concentrated where the rails cross the joists, which may put too much load on top chords of the joists where the rails cross the joists, particularly under high snow load conditions. In these and other embodiments, one or more snow feet may be added to such PV systems to bear most of the load and place it parallel to the joists to more favorably distribute the load across the roof. Such snow feet may be retrofitted into existing PV systems and may be included in new PV systems as they are built.

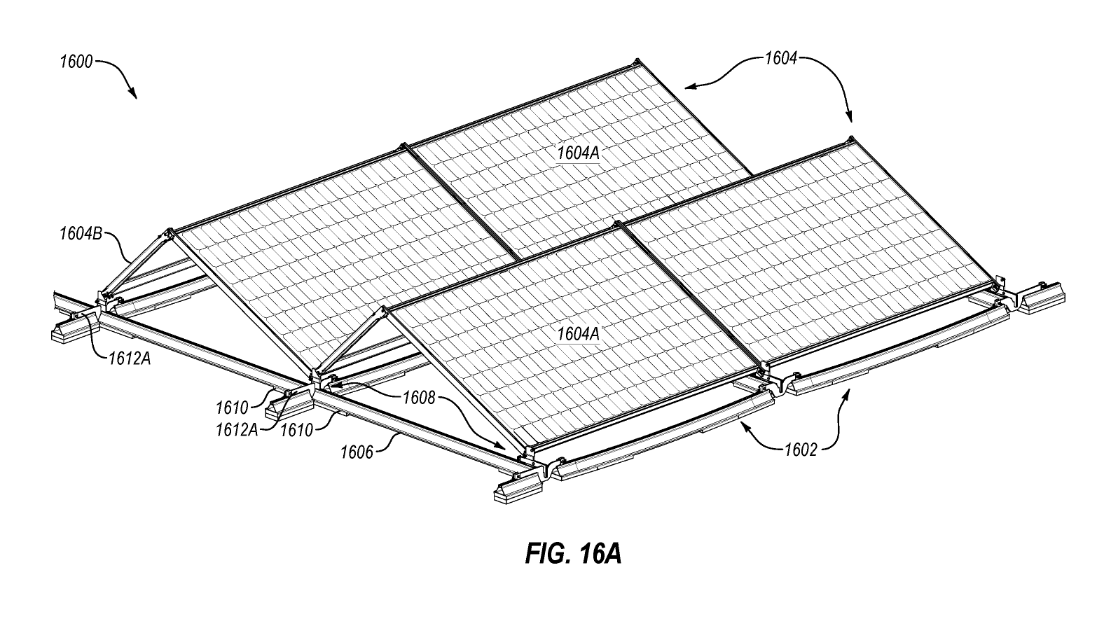

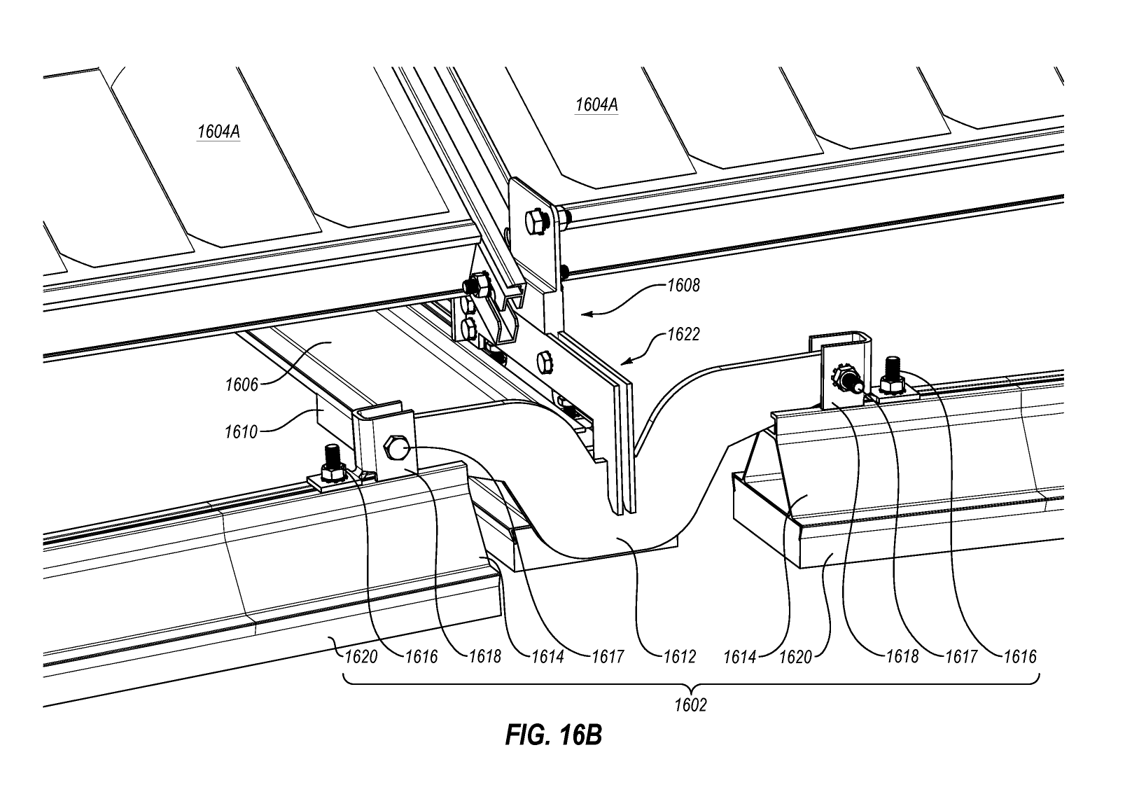

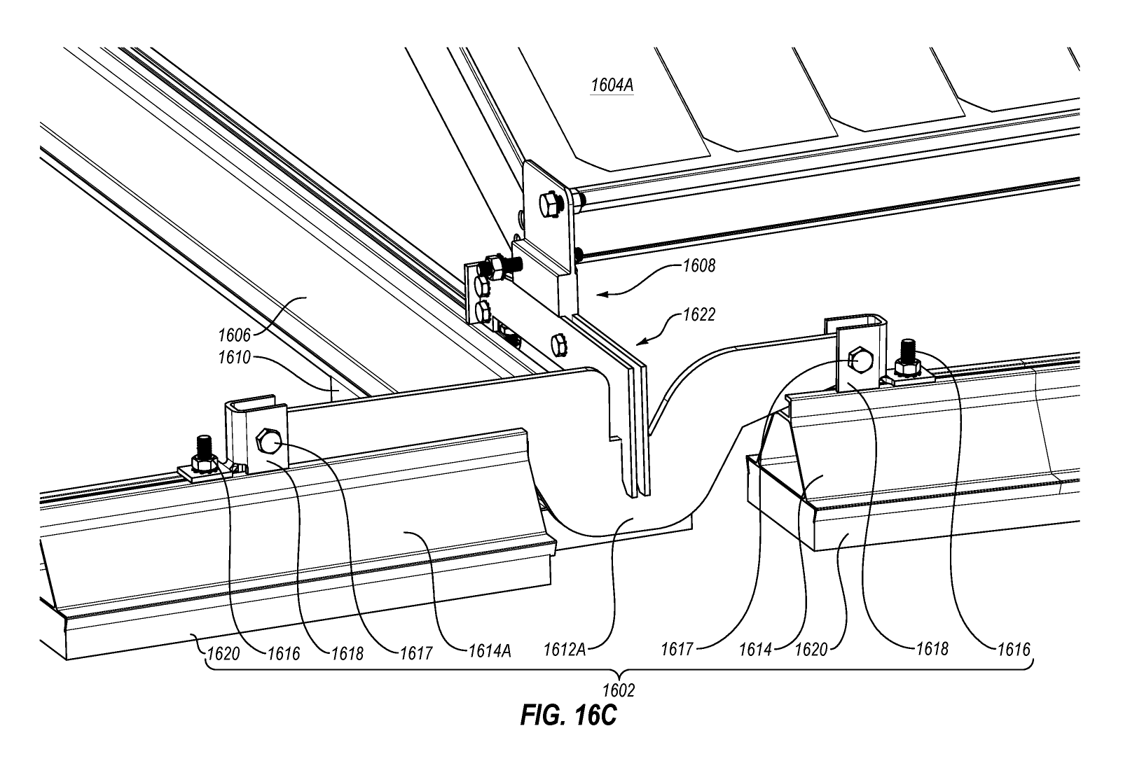

In this regard, FIG. 16A is a perspective view of an example asymmetric wave PV system 1600 (hereinafter “system 1600”) that includes snow feet 1602, arranged in accordance with at least one embodiment described herein. The system 1600 additionally includes wavelets 1604, each made up of a first panel member 1604A and a second panel member 1604B, rails 1606, fin assemblies 1608, and pads 1610. Only some of the snow feet 1602, wavelets 1604, first and second panel members 1604A and 1604B, rails 1606, fin assemblies 1608, and pads 1610 are labeled in FIG. 16A for simplicity. The wavelets 1604, rails 1606, fin assemblies 1608, and pads 1610 may respectively include or correspond to the wavelets 104, rails 106, fin assemblies 108, and pads 110 described elsewhere herein.

Each of the first and second panel members 1604A and 1604B may include a PV module such as the PV modules 102 and 800 described elsewhere herein. Alternatively, the first panel members 1604A may each include a PV module such as the PV modules 102 and 800 while the second panel members 1604B may each include a reflector. The wavelets 1604 may be asymmetric wavelets by using first panel members 1604A of one size and second panel members 1604B of a different size, and/or by supporting lower edges of the first panel members 1604A at different heights than lower edges of the second panel members 1604B.

In an example embodiment, the snow feet 1602 may be configured to support, from an underside of fins included in the fin assemblies 1608, most (e.g., >50%) or all the weight of the system 1600, and pass most or all of the weight of the system 1600 to snow foot rails described below that are included in each snow foot 1602 and that span the gap between parallel lines of the rails 1606.

FIG. 16B is a detail perspective view of a portion of the system 1600 of FIG. 16A, arranged in accordance with at least one embodiment described herein. As illustrated in FIG. 16B, each snow foot 1602 may include a cradle 1612 and two snow foot rails 1614. Each snow foot 1602 may further include fasteners 1616, fasteners 1617, clamps 1618, and snow foot pads 1620.

In some embodiments, the cradle 1612 may be positioned immediately beneath and in direct contact with the fin assembly 1608. In other embodiments, the cradle 1612 may be horizontally displaced from the fin assembly 1608 in the direction of the rails 1616 where a fin-to-cradle weight-transfer bracket assembly (hereinafter “bracket assembly”) 1622 may be used to transfer weight of the system 1600 to the snow foot 1602 through the fin assembly 1608, the bracket assembly 1622, and the cradle 1612. In an example, the cradle 1612 may be laser cut from 3/16″ Aluminum sheet metal.

Each of the two snow foot rails 1614 may be arranged normal to the rails 1606 and may have the same or different cross-sectional shape as the rails 1606 or other rails described herein. For example, in FIG. 16B the rails 1606 and the snow foot rails 1614 may have the same or a similar cross-sectional shape as the rail 500B of FIG. 5B. Thus, each of the rails 1606 and the snow foot rails 1614 may have an open slot similar to the open slot 502 running along the top of each of the rails 1606 and snow foot rails 1614. In addition, each of the snow foot rails 1614 may span a corresponding gap between the rail 1606 illustrated in FIG. 16B and parallel rails 1606 spaced apart to either side of the rail 1606 illustrated in FIG. 16B.

As illustrated in FIG. 16B, opposite ends of the cradle 1612 displaced to opposite sides of the fin assembly 1608 are received into the open slots of the snow foot rails 1614 to either side of the fin assembly 1608 and the snow foot rails 1614 support most or all of the weight transferred through the fin assembly 1608 and the cradle 1612 to the snow foot rails 1614. The left end of the cradle 1612 is coupled to the left snow foot rail 1614 by the left clamp 1618 and the left fasteners 1616 and 1617. The right end of the cradle 1612 is coupled to the right snow foot rail 1614 by the right clamp 1618 and the right fasteners 1616 and 1617.

Each of the snow foot rails 1614 may have a length that is approximately equal to the width of the corresponding gap between the rail 106 illustrated in FIG. 16B and the corresponding parallel rail 106 spaced apart therefrom such that the snow foot rails 1614 may be unable to walk away from the cradle 1612.

The snow foot 1602 illustrated in FIG. 16B additionally includes the bracket assembly 1622. The bracket assembly 1622 as illustrated includes two generally L-shaped supports coupled together with fasteners with a fin of the fin assembly 1602 secured therebetween. The bracket assembly 1622 may be configured to transfer weight of the system 1600 to the cradle 1612 of the snow foot 1602 without having the fin assembly 1608 resting on and in direct contact with the cradle 1612. In some embodiments, each snow foot 1602 along a front or rear perimeter edge of the system 1600 may include a bracket assembly such as the bracket assembly 1622, as illustrated in FIG. 16A. Alternatively or additionally, the cradle 1612 may be sandwiched between two rails 1606 generally arranged end to end and without the use of a bracket assembly (such as the bracket assembly 1622), analogous to the arrangement illustrated in FIG. 16A for two extended cradles 1612A.

FIG. 16C is a detail perspective view of another portion of the system 1600 of FIG. 16A, arranged in accordance with at least one embodiment described herein. FIG. 16C depicts an alternative arrangement of the snow foot 1602 that may be implemented along opposite perimeter edges of the system 1600, e.g., at the edges of each row of wavelets 1604. In comparison, the snow foot 1602 illustrated in FIG. 16B may be suitable within an interior of each row of wavelets 1604.

The snow foot 1602 of FIG. 16C may include at least some of the same components as the snow foot 1602. In particular, each snow foot 1602 along opposite perimeter edges of the system 1600 may include, as illustrated in FIG. 16C, one full-size snow foot rail 1614 that spans the gap between the rail 1606 illustrated in FIG. 16C and a parallel and spaced apart rail 1606, as well as the fasteners 1616, the fasteners 1617, the clamps 1618, and the snow foot pads 1620. The snow foot 1602 of FIG. 16C additionally includes the extended cradle 1612A instead of the cradle 1612 and a stub snow foot rail 1614A instead of the second full-size snow foot rail 1614 as in FIG. 16B.

The extended cradle 1612A includes one side that is longer than the other, whereas the cradle 1612 has two sides of the same length that may be equal to the length of the short side of the extended cradle 1612A. The extended cradle 1612A may better distribute weight to the stub snow foot rail 1614A than the cradle 1612.

As with the cradle 1612 in the snow foot 1602 of FIG. 16B, the extended cradle 1612A in the snow foot 1602 of FIG. 16C may include the bracket assembly 1622, e.g., when implemented along a front or rear perimeter edge of the system 1600. Alternatively or additionally, the extended cradle 1612A may be sandwiched between two rails 1606 generally arranged end to end, as depicted for the extended cradles 1612A in FIG. 16A.

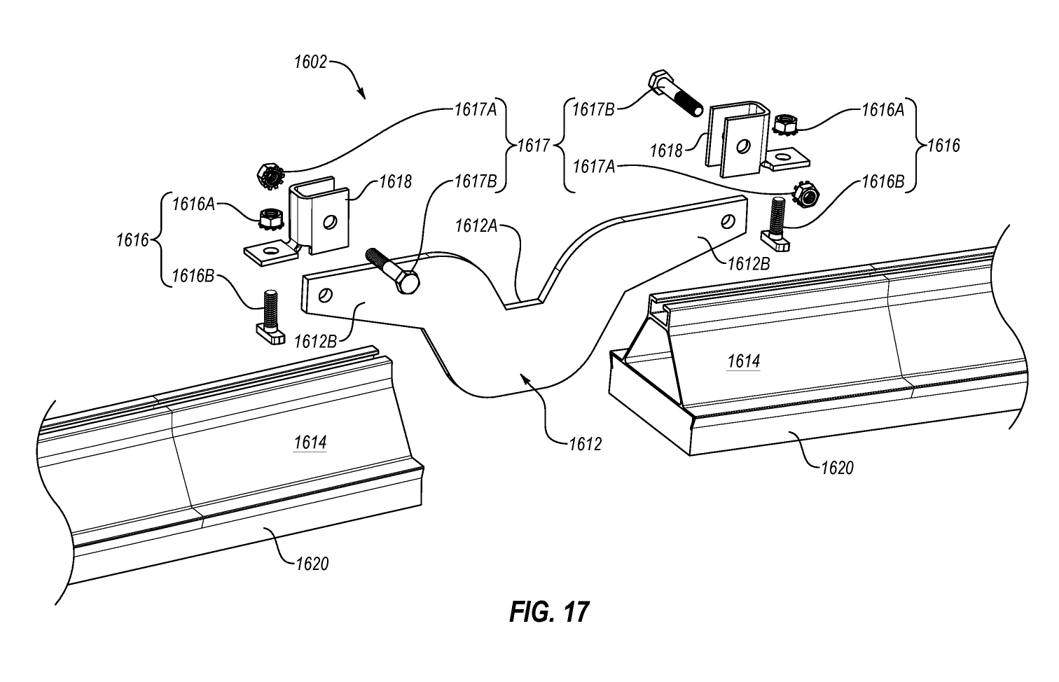

FIG. 17 is an exploded perspective view of the snow foot 1602 of FIG. 16B, arranged in accordance with at least one embodiment described herein. In the illustrated embodiment, each of the fasteners 1616 includes a nut 1616A and a T-bolt 1616B, each fastener 1616 configured to couple the corresponding clamp 1618 to the corresponding snow foot rail 1614. A head of the T-bolt 1616B may be sized to be received within the shoulders of the open slot of the snow foot rails 1614, while a shaft of the T-bolt 1616B may be sized to extend upward through the neck of the open slot of the snow foot rails. FIG. 17 additionally illustrates the fasteners 1617, each including a nut 1617A and a bolt 1617B and configured to couple the corresponding clamp 1618 to the cradle 1612.

The load may be preferentially biased toward the snow foot rails 1614. In particular, the bottom of a valley 1612A of the cradle 1612 where the fin assembly 1608 rests may be vertically offset above bottoms of arms 1612B of the cradle 1612 at locations where the arms 1612 rest on the snow foot rails 1614 (hereinafter “bottom rest locations”). For instance, the bottom of the valley 1612A may be vertically offset above bottom rest locations of the arms 1612B by 0.25″ or some other distance. When the bottom of the valley 1612A where the fin assembly 1608 is supported by the cradle 1612 is vertically offset above the bottom rest locations of the arms 1612B, most or all of the load of the system 1600 transferred to the cradle 1612 may be transferred by the cradle 1612 to the snow foot rails 1614 rather than to the rails 1606.

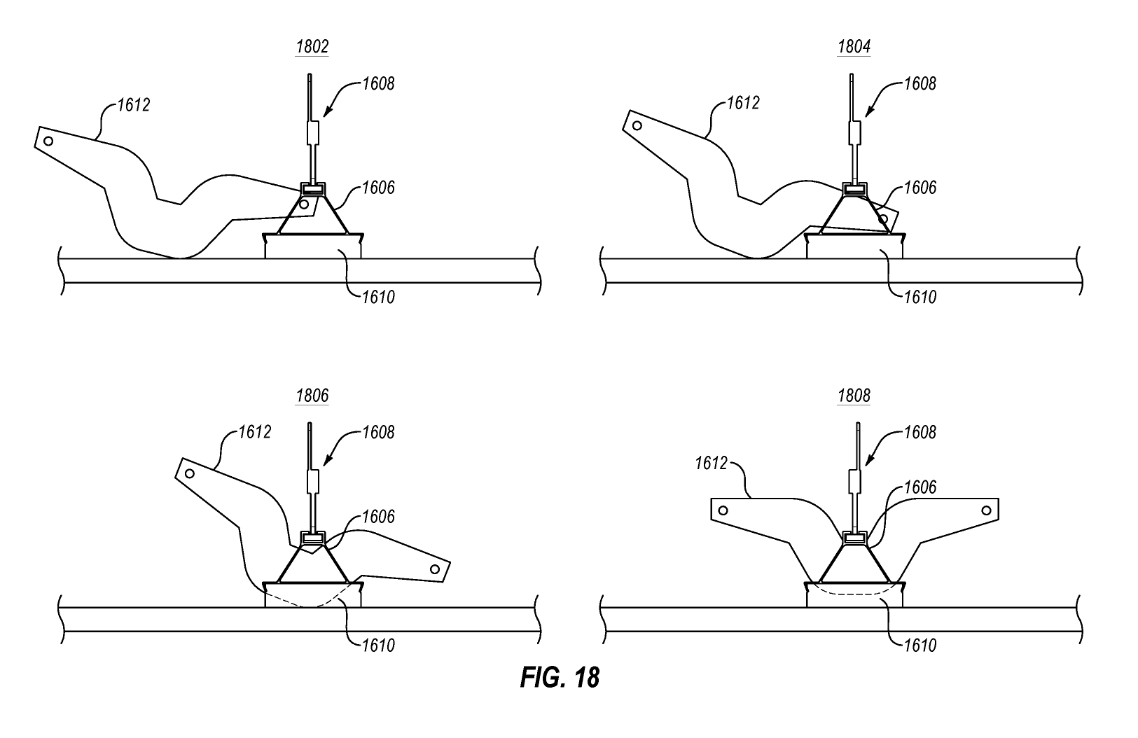

FIG. 18 illustrates an example method 1800 to install cradles 1612 in an existing PV system, such as the system 1600 of FIG. 16A, arranged in accordance with at least one embodiment described herein. After the cradles 1612 have been installed, it may be relatively straightforward to install corresponding complete snow foot 1602 by installing the snow foot rails 1614 and/or 1614A in the appropriate locations and to couple the cradles 1612 to the snow foot rails 1614 and/or 1614A using the fasteners 1616 and the clamps 1618. It is assumed in FIG. 18 that the existing PV system in which the cradles 1612 are installed is the system 1600 of FIG. 16A.

In FIG. 18, a line of rails 1606 is visible in an end elevation view, together with a fin assembly 1606 coupled between two rails 1606 in the line of rails 1606 where the two rails 1606 are arranged end to end. At various stages (e.g., 1804, 1806, and 1808) of the method 1800 of FIG. 18, portions of the cradle 1612 may be behind the pad 1610. In such circumstances, an outline of the portions of the cradle 1612 which would not be visible in an actual installation are provided as a reference.

At 1802, the cradle 1612 may be aligned with a gap between the two rails 1606 in the line of rails 1606 that are arranged end to end and the cradle is tipped to insert one of its ends 1612B (FIG. 17) into the gap between the rails 1606 and under the fin assembly 1608. At 1804 and 1806, the cradle 1612 is maneuvered further into and through the gap until the valley 1612A (FIG. 17) of the cradle 1612 is located beneath the fin assembly 1608, as illustrated at 1808. In some embodiments, the rails 1606, the fin assembly 1608, and the wavelets 1604 (FIG. 16A) coupled to the rails 1606 through the fin assembly 1608 may be lifted slightly (e.g., a few centimeters or more) by an installer to get the snow foot rails 1614 and/or 1614A (FIGS. 16B and 16C) beneath the ends 1612B of the cradle 1612 to get the ends 1612B of the cradle 1612 properly seated with respect to the snow foot rails 1614 and/or 1614A.

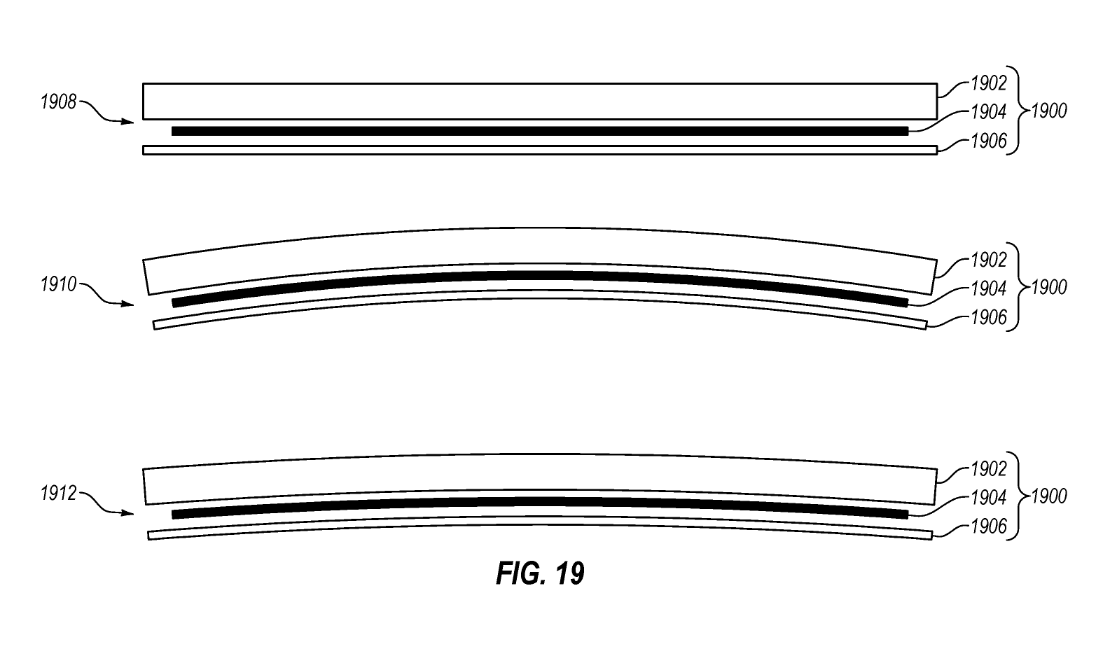

FIG. 19 is an elevation view of an example material stackup 1900 that may be implemented in a PV module, arranged in accordance with at least one embodiment described herein. For instance, one or more of the PV modules 102 and 800 described above may have the material stackup 1900. In general, the material stackup 1900 may include a glass layer 1902 or other transparent layer, a PV cell layer 1904, and a conductive backsheet 1906. The material stackup 1900 may include one or more other layers which have been omitted from FIG. 19 for simplicity. The one or more other layers may include one or more adhesive layers, one or more electrically insulative layers, one or more buffer layers, and/or one or more other layers.

The PV cell layer 1904 may include an array of PV cells arranged in rows and columns, where all the PV cells within each row are electrically coupled together in parallel and the rows of PV cells are electrically coupled together in series, as described with respect to the PV module 800 of FIG. 8.

The conductive backsheet 1906 may include an aluminum backsheet or a backsheet of other electrically conductive material. The conductive backsheet 1906 may complete a circuit between a first row and a last row of the PV cells in the cell layer, as described in the other patents and patent publications incorporated herein by reference. The conductive backsheet 1906 may function as a stiffener and curvature element in the material stackup 1900 and may have very high temper in some embodiments, such as H19, also referred to as ultra-hard temper with a very high yield strength.

The conductive backsheet 1906 may also have a higher coefficient of thermal expansion than the glass layer 1902, which can be exploited to form the material stackup 1900, and thus PV modules that include the material stackup 1900, with a curvature. In particular, as illustrated at 1908, the material stackup 1900 may be heated to an elevated temperature during a lamination process to laminate the material stackup 1900 together. Due to the difference in the coefficients of thermal expansion of the conductive backsheet 1906 and the glass layer 1902, the conductive backsheet 1906 may expand more than the glass layer 1902. With the layers of the material stackup 1900 laminated together following the lamination process, the material stackup 1900 cools when no longer subjected to the elevated temperature used for lamination. Because the conductive backsheet 1906 expands more than the glass layer 1902 when heated to the elevated temperature, it also shrinks more than the glass layer 1902 when allowed to cool, thereby inducing a curvature in the material stackup 1900 as illustrated at 1910. As illustrated at 1912, with a load applied to the material stackup 1900, the curvature of the material stackup 1900 may be reduced, which may reduce a residual state of stress for PV cells in the PV cell layer 1904 and increase tension in the conductive backsheet 1906.

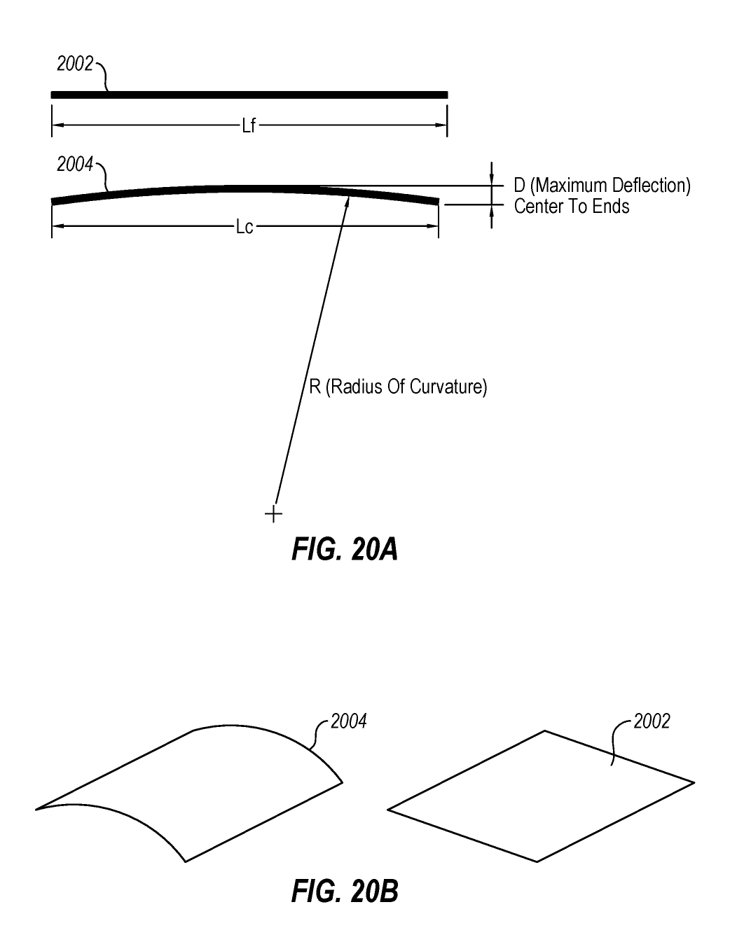

FIGS. 20A and 20B include views of a flat PV module 2002 and a curved PV module 2004, arranged in accordance with at least one embodiment described herein. FIG. 20A includes a side elevation view and FIG. 20B includes a perspective view of the flat and curved PV modules 2002 and 2004. FIG. 20A illustrates various parameters associated with the flat and curved PV modules 2002 and 2004. The parameters include a length L_{f} of the flat PV module 2002, a length L_{c} of the curved PV module 2004, a radius of curvature R of the curved PV module 2004, and a depth of curvature D of the curved PV module 2004.

The curved PV module 2004 may include generally cylindrical curvature, where the curvature is present only in one direction, e.g., along short edges of the curved PV module 2004, as illustrated in FIG. 20B. In the orientation of FIG. 20B, and assuming the curved PV module 2004 includes PV cells with parallel and serial connections described above with respect to FIG. 8, and assuming the parallel and serial connections of the PV cells are as noted in FIG. 20B, the curved PV module 20B can generate significant power notwithstanding the non-uniform illumination conditions the PV cells will be exposed to by virtue of the curvature of the curved PV module 204. In comparison, a conventional PV module with serially connected PV cells in a string cannot be curved due to non-linear losses created by limiting the illumination of light to any cell in the string.

An amount of curvature of the curved PV module 2004 may be so large the curved PV module 2004 looks like a skylight, or so small that the curvature is not easily detected visually, or anywhere in between. In the example of FIG. 20A, the amount of curvature results in the depth of curvature D of the curved PV module 2004 being about 3″ over a total flat length of 51.5″, e.g., the length L_{f} of the flat PV module 2002 that the curved PV module 2004 may have if it were not curved. More generally, the depth of curvature D of the curved PV module 2004 may be in a range of 1-4 inches over an arch length of the curved PV module 2004. The arch length of the curved PV module 2004 may be about 51.5 inches (e.g., equivalent to the length L_{f} of the flat PV module 2002). More generally, the arch length of the curved PV module 2004 may be in a range from 50-200 inches. The amount of curvature of FIG. 20A may equate to the radius of curvature R of the curved module 2004 of 110″. The curvature may be the same, less, or more at the ends of the curved PV module 2004 than in the middle. In the example of FIG. 20A, the ends of the curved PV module 2004 may be +/−7° versus the center. FIG. 20A also includes various calculations involving the length L_{f} of the flat PV module 2002, the length L_{c} of the curved PV module 2004, the radius of curvature R of the curved PV module 2004, and the depth of curvature D of the curved PV module 2004 according to an example embodiment.

As described with respect to FIG. 19, the conductive backsheet 1906 that may be implemented in some PV modules described herein may naturally pull the curved PV module 2004 into the cylindrically curved shape, e.g., due to tension formed during cooling from lamination. Due to anti-claustic effects, the laminated material stackup 1900 may distort into a single curvature, either bowing exclusively along the long direction or exclusively along the short direction, but generally not into a complex and/or spherical shape. The PV module 800 of FIG. 8 is described as including the frame 808 that may generally be flat. In comparison, the curved PV module 2004 of FIGS. 20A and 20B may have a frame with one or more sections that are shaped, e.g., curved, to match, amplify, or partially suppress the curvature of the material stackup included in the curved PV module 2004.

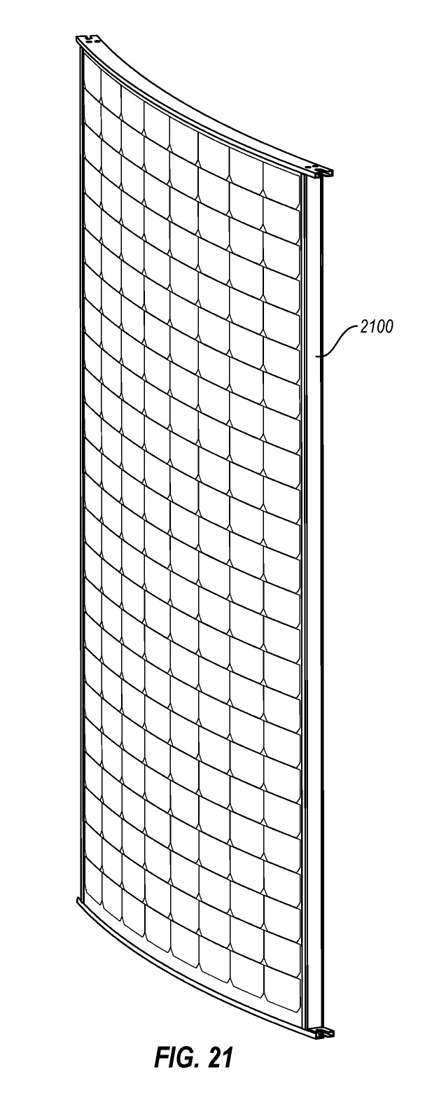

FIG. 21 illustrates a perspective view of another curved PV module 2100, arranged in accordance with at least one embodiment described herein. The curved PV module 2100 is not in an installed orientation. From the viewing angle of FIG. 21, a slight curvature can be seen along top and bottom edges of the curved PV module 2100.

Conventional PV modules may use plastic backsheets which may have less strength in tension or compression than the aluminum or other conductive backsheets (e.g., conductive backsheet 1906) that may be implemented in some PV modules described herein. As such, the glass layer or superstrate used in conventional PV modules may be the primary support for conventional PV modules, which glass layer or superstrate may be most economically made as a flat glass layer or superstrate. If frames in such conventional PV modules were used to induce curvature, the curvature would be resisted by the flat glass layer or superstrate and may result in PV cells cracking and/or residual stress damage.

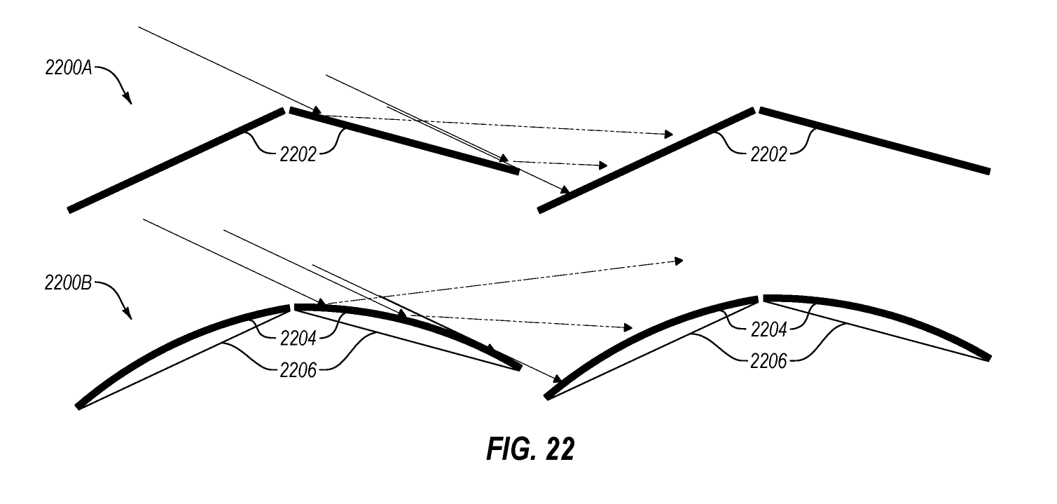

In comparison, PV modules according to some embodiments described herein may include an aluminum or other conductive backsheet as described with respect to FIG. 19, which is more robust and provides more support than the plastic backsheets used in conventional PV modules. Curved PV modules such as the curved PV modules 2004 and 2100 that include an aluminum or other conductive backsheet may use a thinner glass layer or superstrate (e.g., the glass layer 1902 of FIG. 19) than conventional PV modules and/or flat PV modules. For instance, referring to FIG. 20B, when a thin flat plate such as a glass layer or superstrate that may be included in the flat PV module 2002 deflects, the only resistance to deflection comes from bending resistance of the thin flat plate for small deflections. As the deflection increases, other resistive forces such as in-plane (axial) forces (tension or compression) begin to help resist the deflection (sometimes referred to as membrane forces for thin plates). In comparison, a curved thin plate, such as a thin glass layer or superstrate that may be included in the curved PV module 2004, that is adequately supported along its edges enjoys the in-plane resistance immediately upon loading since any deflection requires the curved thin plate to compress, making it much stiffer than the flat thin plate (assuming the plates are of equal thickness). Thus, the curved PV module 2004 may use a thinner glass layer or superstrate than the flat PV module 2002 while maintaining or exceeding the resistance to deflection of the flat PV module 2002. In some embodiments, the curved PV module 2004 may include one or more tension cables such as described in more detail with respect to FIG. 22.

Using thinner glass in the curved PV module 2004 may reduce optical loss through the glass layer or superstrate which may in turn increase energy generated by the curved PV module 2004. Alternatively or additionally, using thinner glass in the curved PV module 2004 may reduce the total weight of the curved PV module 2004, which may in turn reduce shipping costs for the curved PV module 2004 and/or make moving the curved PV module 2004 around during installation easier. As an example, the glass layer or superstrate used in the flat PV module 2002 may be about 3.2 mm thick, while the thickness of the glass layer or superstrate in the curved PV module 2004 may be reduced to 2.6 mm or even to 2.0 mm to reduce the weight of the curved PV module 2004 compared to the flat PV module 2002 by about seven pounds or even fourteen pounds in some embodiments.

Curved PV modules such as the curved PV module 2004 may alternatively or additionally have better energy profiles than the flat PV modules such as the flat PV module 2002. For instance, compared to a flat PV module, a curved PV module at a south facing tilt (in the Northern Hemisphere) on a rooftop may have a better diffuse and albedo collection component and less Fresnel loss to the sides of the curved PV module since the sides of the curved PV module may be better aligned to the side albedo. When the sun is directly overhead, the module power of the curved PV module may be reduced compared to the flat PV module since the curvature of the curved PV module causes some of the curved PV module to be tilted away from the sun, which may give the curved PV module a desirably flatter energy profile than the flat PV module. The energy profile can be further enhanced by using mixed PV cells in the curved PV module, where higher efficiency PV cells are placed at the edges and lower efficiency PV cells are placed in the center of the curved PV module.

When flat PV modules are installed at low tilts, they are often plagued by soiling and snow coverage. Lower edges of flat PV modules are particularly prone to debris/soiling and/or snow accumulation. In comparison, curved PV modules with arced surfaces may provide a more favorable set of angles for natural washing to reduce the negative effects of soiling and snow coverage compared to flat PV modules. For instance, lower edges of curved PV modules may be at steeper angles than lower edges of flat PV modules, improving natural washing and/or snow slide off of curved PV modules at least at their lower edges.

Alternatively or additionally, a PV system made up of curved PV modules may have improved aesthetics compared to PV systems made up of flat PV modules. PV systems made up of curved PV modules may avoid the issue of “magnifying” imperfections caused by slight misalignments of adjacent PV modules which may arise in PV systems with flat PV modules.

Alternatively or additionally, curved PV modules may have improved hail resistance compared to flat PV modules. Compared to flat PV modules, the incident angle of incoming hailstones to curved PV modules may be increased over some or all of the curved surface, which may result in a more glancing angle and a reduction in the energy of impact.

Alternatively or additionally, a PV system made up of curved PV modules may have enhanced cooling compared to PV systems made up of flat PV modules. In particular, the space under curved PV modules may be greater than the space under flat PV modules, which may result in more space for air circulation. In this and other embodiments, the additional space under curved PV modules may be used to accommodate more and/or larger inverters, batteries, and/or other components than can be accommodated in the space under flat PV modules.

FIG. 22 is a simplified side view of two asymmetric wave PV systems 2200A and 2200B (collectively “systems 2200”), arranged in accordance with at least one embodiment described herein. The asymmetric wave PV system 2200A includes flat PV modules 2202 arranged in asymmetric wavelets and may hereinafter be referred to as the flat module system 2200A. The asymmetric wave PV system 2200B includes curved PV modules 2204 arranged in asymmetric wavelets and may hereinafter be referred to as the curved module system 2200A. Each of the systems 2200 may include one or more of the rails, fin assemblies, pads, and/or other elements described elsewhere herein, which elements have been omitted from FIG. 22 for simplicity. In FIG. 22, the flat and curved PV modules 2202, 2204 facing to the left are front PV modules (referred to as front flat PV modules 2202 and front curved PV modules 2204) while the flat and curved PV modules 2202, 2204 facing to the right are rear PV modules (referred to as rear flat PV modules 2202 and rear curved PV modules 2204) consistent with the nomenclature used elsewhere.

Alternatively or additionally, asymmetric wave PV systems such as described herein may include a mix of both flat PV modules 2202 and curved PV modules 2204. For instance, an asymmetric wave PV system may include flat PV modules 2202 facing south or north and curved PV modules 2204 facing the opposite direction as the flat PV modules 2202.

As illustrated in FIG. 22, in some embodiments, each of the curved PV modules 2204 may include one or more tension cables 2206. Each tension cable 2206 may extend from straight edge to straight edge of the curved PV modules 2204 (straight edges are arranged in and out of the page in FIG. 22) to impart and/or maintain the curvature of each of the curved PV modules 2204. In some embodiments, each of the curved PV modules 2204 includes a single tension cable 2206 coupled to a middle of one of the straight edges at one end and to a middle of the other of the straight edges at the other end. In other embodiments, each of the curved PV modules 2204 may include two or more tension cables 2206 spaced along the straight edges at different locations. For instance, for two tension cables 2206, one may have its ends coupled to the straight edges at a location about one third of the length of the straight edges while the other tension cable 2206 may have its ends coupled to the straight edges at a location about two thirds of the length of the straight edges.

FIG. 22 additionally illustrates ray diagrams for incoming low angle illumination and reflected illumination. It can be seen from the ray diagrams that for a same horizontal offset between lower edges of front and rear PV modules 2202, 2204 in the systems 2200, there may be less shading at the lower edge of each front curved PV modules 2204 than at the lower edge of each front flat PV module 2202. It can also be seen from the ray diagrams that the upper edge of each rear curved PV module 2204 is better aligned to the incoming low angle illumination than the upper edge of each rear flat PV module 2202, resulting in better direct absorption and less reflection at the upper edge of each rear curved PV module 2204. It can further be seen from the ray diagrams that the reflected illumination from the curved PV modules 2204 expands, which may be safer than concentrated reflected illumination that may be reflected by the flat PV modules 2202.

Table 1 below shows measured Standard Test Conditions (STC) power of four PV modules in an experiment. Two of the PV modules have a relatively thick glass layer or superstrate (labeled “3.2mmGlass” in Table 1) and two of the PV modules have a relatively thin glass layer or superstrate (labeled “2.6mmGlass” in Table 1). Also two of the PV modules are flat (labeled “Normal Frame” in Table 1) and two of the PV modules are curved (labeled “Curve Frame” in Table 1).

TABLE 1

| | | | STC |
|---|---|---|---|
| | Glass | Max Power (W) | Max Power (W) |
| Normal Frame | 3.2 mm Glass | 389.6 | 421.5 |
| | 2.6 mm Glass | 388.3 | 419.3 |
| Curve Frame | 3.2 mm Glass | 383.5 | 422.6 |
| | 2.6 mm Glass | 387.1 | 420.9 |

As seen from Table 1, the power is lower in both cases with the thin glass compared to the thick glass, contrary to expectations. However, the thin glass was provided by a different vendor than the thick glass, so the deviation from expectations may be related to antireflective (AR) glass coating differences and/or other differences between the thin and thick glass. Regarding the curved PV modules versus the flat PV modules, the curved PV modules have an STC Max Power increase of 0.3% or 0.4%, respectively, compared to the flat PV modules with the corresponding glass thickness.

As depicted in the calculations of FIG. 20A, the curved shape of the curved PV module 2004 results in a shorter length, by 1.04″ or 2% of the length, of the curved PV module 2004 compared to the flat PV module 2002. If PV module pitch in an asymmetric wave PV system such as illustrated in, e.g., FIGS. 1A, 1B, and 22 is adjusted to account for this length change with curved PV modules, the resulting asymmetric wave PV system may have a rooftop power density increase of 2% compared to an asymmetric wave PV system with flat PV modules. Adding in the 0.4% STC Max power increase shown in Table 1 may result in a net increase in rooftop power density of 2.4% compared to using flat PV modules.

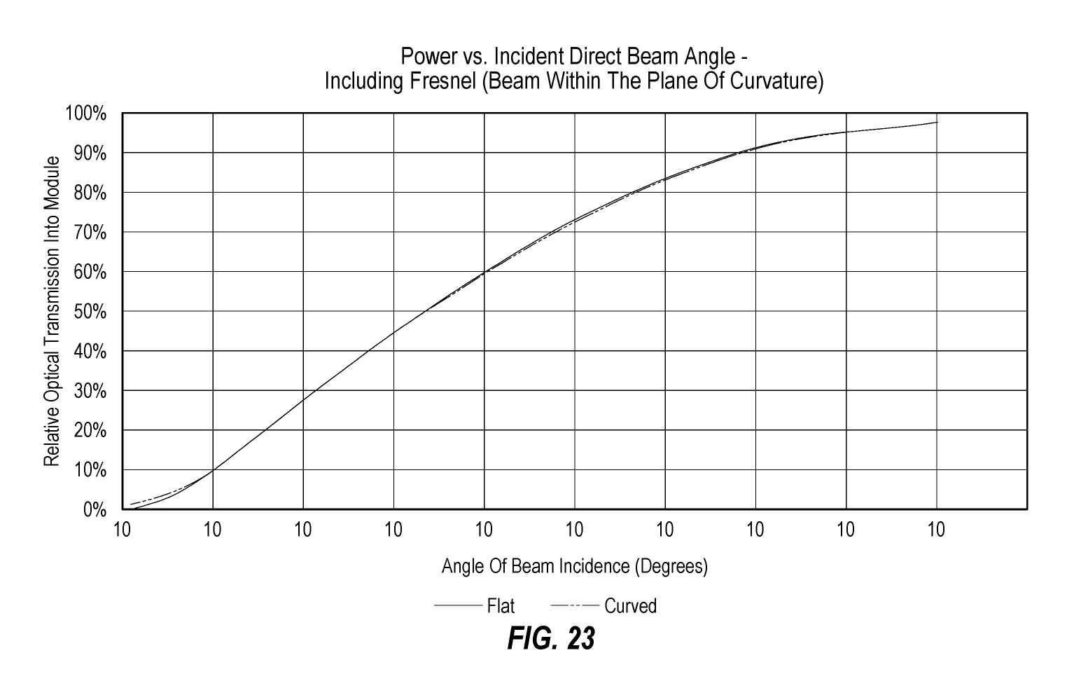

Curved PV modules under direct light have the effect of changing how each of the PV cells is illuminated. Assume the sun is optimally aligned over a flat PV module. The optical transmission of AR glass results in a loss of several percent (reflected). For a curved PV module, the center PV cells may absorb similar to the PV cells in the flat PV module, however the PV cells near the edges of the curved PV module have a poorer alignment, and thus more loss. A set of Fresnel calculations were performed to determine the loss associated with this, assuming an AR coating of 1.25 and a glass index of 1.57. Reflections and TIR from a silicon interface included in the curved PV module in this model are ignored. FIG. 23 is a graphic of the results of the foregoing Fresnel model, showing the energy differences created by this added misalignment, arranged in accordance with at least one embodiment described herein. FIG. 23 shows the impact to be an added ˜0.3% loss in the curved PV module compared to the flat PV module at grazing angles above about 10°. In the case of the curved PV module, the angle of incidence is measured with respect to the slope of the curved PV module at the center of the curved PV module. Below 10°, the curved PV module shows better absorption due to the curved PV module having PV cells that are better directed to the incoming direct beam (one reason skylights are curved) than the flat PV module. This difference in loss should apply to the STC power factors discussed previously. However also note on the light table used to measure STC power, the optical conditions are not collimated as they are outdoors.

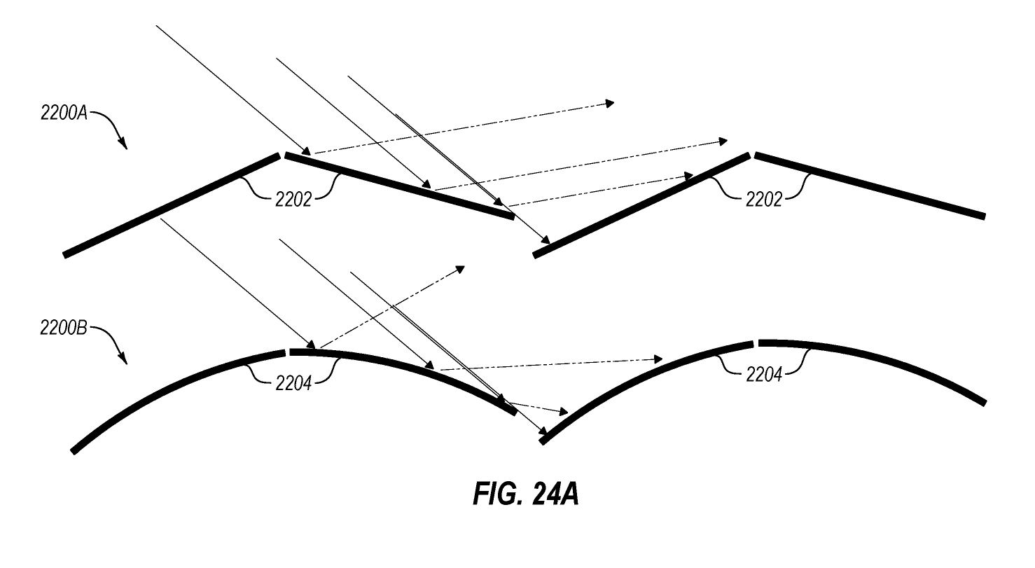

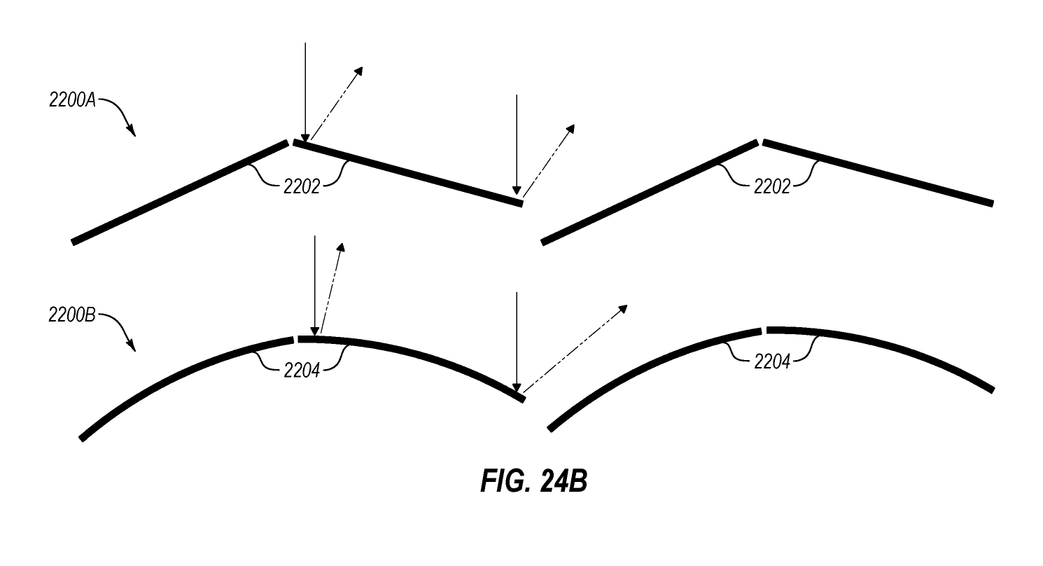

Also note the Fresnel model of FIG. 23 is for stand-alone PV modules (e.g., a stand-alone curved PV module and a stand-alone flat PV module, each modeled separately). For a pair of PV modules in an asymmetric wave PV system such as in, e.g., FIGS. 1A, 1B, and 22, optical reflections from various incoming illumination angles as illustrated in, e.g., FIGS. 22, 24A, and 24B should not be ignored. In this regard, FIGS. 24A and 24B include simplified side views of the systems 2200 of FIG. 22, along with ray diagrams for incoming illumination and reflected illumination at different angles than in FIG. 22, arranged in accordance with at least one embodiment described herein. The effects of reflection are significantly different between the systems 2200.

In more detail, in FIGS. 22, 24A, and 24B, it can be seen that the lower edges of the rear curved PV modules 2204 are at a steeper or higher angle than the lower edges of the rear flat PV modules 2202. The higher angle at the lower edges of the rear curved PV modules 2204 may make the rear curved PV modules 2204 much more effective reflectors than the rear flat PV modules 2202 to thereby improve reflected light recapture (hereinafter “recapture”) in the curved module PV system 2200B compared to the flat module PV system 2200A. For instance, in FIG. 24A, it can be seen that for an incoming illumination angle of 40°, most of the reflected illumination from the rear flat PV module 2202 is reflected over the top of the adjacent front flat PV module 2202 whereas a relatively greater amount of the reflected illumination from the rear curved PV module 2204 is reflected onto the adjacent front curved PV module 2204. The improved recapture plus reduced shading loss for the curved module PV system 2200B may result in a 0.5-0.25% gain in annual energy production compared to the flat module PV system 2200A. In addition, similar to FIG. 22, in FIGS. 24A and 24B, the upper edge of each rear curved PV module 2204 is better aligned to the incoming illumination than the upper edge of each rear flat PV module 2202, resulting in better direct absorption and less reflection at the upper edge of each rear curved PV module 2204 under the incoming illumination angles depicted in FIGS. 22, 24A, and 24B.

In the curved module PV system 2200B, if the front curved PV modules 2204 are arranged to face south and the curvature of each curved PV module 2204 is along its side edges that connect the upper edge to the lower edge, the curvature may enhance the sky view of each curved PV module 2204 at small incident angles and may result in an increase in diffuse collection. In the curved module PV system 2200B, if the front curved PV modules 2204 are arranged to face west and the curvature of each curved PV module 2204 is along its side edges that connect the upper edge to the lower edge, the curvature may enhance early AM and/or late PM energy collection as there is significant diffuse energy during these time periods that may be more efficiently collected than in the flat module PV system 2200A. Some estimates show a 0.3-0.5% gain in diffuse collection when the front curved PV modules 2204 are arranged to face south and up to a 1.2% gain in diffuse collection when the front curved PV modules 2204 are arranged to face west.

FIG. 25A is an overhead perspective view of an example implementation of the system 100B of FIG. 1B installed on a sloped installation surface 2500 (hereinafter “surface 2500”), arranged in accordance with at least one embodiment described herein. The surface 2500 may have a relatively shallow slope. The surface 2500 may additionally include a plurality of spaced apart ridges 2502 (hereinafter “ridges 2502”), only some of which are labeled in FIG. 25A (and in FIG. 25B) for simplicity.

FIG. 25B is a detailed perspective view of a portion of FIG. 25A, arranged in accordance with at least one embodiment described herein. As illustrated in FIG. 25B, each of the ridges 2502 extends above the surface 2500 by a height referred to as a “ridge height” (not labeled in FIG. 25B). Each of the pads 110 has a thickness referred to as a “pad thickness” (not labeled in FIG. 25B). The pads 110 may be located in spaces horizontally between the ridges 2502 and vertically between the rails 106 and the surface 2500. The pad thickness of each of the pads 110 may be greater than the ridge height of each of the ridges 2502 to support the rails 106, fin assemblies 108 and PV modules 102 above and avoiding direct contact with the ridges 2502. By support the foregoing above and avoiding direct contact with the ridges 2502, the ridges 2502 will not be crushed or otherwise deformed by the load from the system 100B.

As further illustrated in FIG. 25B, one or more ridge clips 2504 may be included in the system 100B to couple the system 100B to the surface 2500. Such a configuration may be desirable to prevent slow slippage of the system 100B down the sloped surface 2500 over time, such as may occur as a result of thermal cycles. In some embodiments, ridge clips 2504 may be provided primarily or solely along a lower perimeter edge (e.g., along the lowest line of rails 106 in FIG. 25A) of the system 100B. Alternatively or additionally, the system 100B may include about one ridge clip 2504 per 10,000 watts (W) of PV modules 102. In comparison, some other PV systems installed on sloped installation surfaces may include about one clip per 300 W of PV modules.

In general, the ridge clip 2504 may couple a corresponding one of the ridges 2502 to a corresponding one of the rails 106 of the system 100B. The ridge clip 2504 illustrated in FIG. 25B may include any suitable configuration. One such suitable configuration is illustrated in FIG. 25B in which the ridge clip 2504 includes a C clamp 2504A with set screws 2504B and a cable screw 2504C. A mouth of the C clamp 2504A is placed over a corresponding one of the ridges 2502 and the set screws 2504B are tightened to clamp or otherwise secure the ridge clip 2504 to the ridge 2502. A compliant cable 2506 or tie or other connector is provided that includes one end coupled to the ridge clip 2504 via the cable screw 2504C and an opposite end coupled to the rail 106.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An asymmetric wave photovoltaic system, comprising:
a plurality of asymmetric wavelets arranged in rows, each of the plurality of asymmetric wavelets including front and rear photovoltaic modules of equal size, wherein:
within each asymmetric wavelet of the plurality of asymmetric wavelets, two upper corners of the front photovoltaic module and two upper corners of the rear photovoltaic module are coupled together to form a peak of the asymmetric wavelet;
for each asymmetric wavelet, the front photovoltaic module includes two lower corners supported at a first height such that the front photovoltaic module is arranged at a first angle relative to horizontal; and
for each asymmetric wavelet, the rear photovoltaic module includes two lower corners supported at a second height that is different than the first height such that the rear photovoltaic module is arranged at a second angle relative to horizontal that is different than the first angle.

2. The asymmetric wave photovoltaic system of claim 1, wherein at the peak of each asymmetric wavelet, an angle between the front photovoltaic module and the rear photovoltaic module is less than or equal to 160 degrees.

3. The asymmetric wave photovoltaic system of claim 2, further comprising:
a first fastener that couples a first one of the two lower corners of the front photovoltaic module to a first fin assembly;
a second fastener that couples a second one of the two lower corners of the front photovoltaic module to a second fin assembly;
a third fastener that couples a first one of the two lower corners of the rear photovoltaic module to a third fin assembly; and
a fourth fastener that couples a second one of the two lower corners of the rear photovoltaic module to a fourth fin assembly,
wherein each of the first, second, third, and fourth fasteners include a clevis pin and a cotter pin or a nut and a bolt.

4. The asymmetric wave photovoltaic system of claim 1, further comprising:
a plurality of rails arranged parallel to each other; and
a plurality of fin assemblies coupled to the at least two rails, wherein the plurality of asymmetric wavelets is coupled to the plurality of rails through the plurality of fin assemblies.

5. The asymmetric wave photovoltaic system of claim 4, wherein each of the plurality of fin assemblies comprises:
a fin that includes base flanges that extend sideways and that are configured to engage with a corresponding one of the plurality of rails and a fin body that extends upwards from the base flanges; and
a riser mechanically coupled to the fin body.

6. The asymmetric wave photovoltaic system of claim 5, wherein:
each of the plurality of rails defines an open slot along at least a portion of a top of the rail;
the open slot has a cross-sectional shape that includes a neck with a neck width and shoulders below the neck that have a shoulder width greater than the neck width;
the base flanges of the fin extend sideways to a width that is greater than the neck width and less than or equal to the shoulder width;
the fin body of the fin has a width less than or equal to the neck width;
the riser is mechanically coupled to the fin body at first and second locations of the riser that are vertically offset from each other;
each riser includes a third location vertically offset from each of the first and second locations of the riser;
the first location of the riser is at the first height and the third location of the riser is at the second height when the riser is mechanically coupled to the fin and the fin is mechanically coupled to the rail;
for each asymmetric wavelet, the two lower corners of the front photovoltaic module are supported at the first height by first and second fin assemblies of the plurality of fin assemblies;
for each asymmetric wavelet, the two lower corners of the rear photovoltaic module are supported at the second height by third and fourth fin assemblies of the plurality of fin assemblies;
a first of the two lower corners of the front photovoltaic module is mechanically coupled to the riser of the first fin assembly at the first location of the riser of the first fin assembly;
a second of the two lower corners of the front photovoltaic module is mechanically coupled to the riser of the second fin assembly at the first location of the riser of the second fin assembly;
a first of the two lower corners of the rear photovoltaic module is mechanically coupled to the riser of the third fin assembly at the third location of the riser of the third fin assembly; and
a second of the two lower corners of the rear photovoltaic module is mechanically coupled to the riser of the fourth fin assembly at the third location of the riser of the fourth fin assembly.

7. The asymmetric wave photovoltaic system of claim 5, wherein:
for each asymmetric wavelet, the two lower corners of the front photovoltaic module are supported at the first height by first and second fin assemblies of the plurality of fin assemblies;
the riser of the first fin assembly is mechanically coupled to the fin of the first assembly tilted relative to horizontal; and
the riser of the second fin assembly is mechanically coupled to the fin of the second fin assembly tilted relative to horizontal,
such that a lower edge of the front photovoltaic module is both horizontally and vertically offset from a lower edge of an adjacent rear photovoltaic module in an adjacent asymmetric wavelet, where the adjacent rear photovoltaic module includes two lower corners supported at the second height by the risers of the first and second fin assemblies.

8. The asymmetric wave photovoltaic system of claim 7, wherein:
a horizontal offset between the lower edge of the front photovoltaic module and the lower edge of the adjacent rear photovoltaic module is in a range from 50 millimeters (mm) to 150 mm; and
a vertical offset between the lower edge of the front photovoltaic module and the lower edge of the adjacent rear photovoltaic module is in a range from 100 mm to 300 mm.

9. The asymmetric wave photovoltaic system of claim 1, wherein:
a peak height of the asymmetric wave photovoltaic system is less than 0.75 meters (m), where the peak height is a height of the peaks of the plurality of asymmetric wavelets above bottoms of the plurality of rails;
a first vertical offset between the first height and the second height is in a range of 100 millimeters (mm) to 300 mm such that a second vertical offset between a lower edge of the front photovoltaic module in each asymmetric wavelet and a lower edge of an adjacent rear photovoltaic module in each corresponding adjacent asymmetric wavelet is in the range of 100 mm to 300 mm; and
a peak-to-valley height of the asymmetric wave photovoltaic system is greater than 0.5 m, where the peak-to-valley height is defined as a vertical distance between a peak and a valley of each of the plurality of asymmetric wavelets.

10. The asymmetric wave photovoltaic system of claim 1, wherein:
the first height at which the two lower corners of the front photovoltaic modules are coupled is less than the second height at which the two lower corners of the rear photovoltaic modules are coupled such that the front photovoltaic modules of the plurality of asymmetric wavelets are arranged at a steeper angle than the rear photovoltaic modules of the plurality of asymmetric wavelets;
in the Northern Hemisphere:
the front photovoltaic modules are arranged to face south, west, or both partially south and partially west; and
the rear photovoltaic modules are arranged to face an opposite direction from the front photovoltaic modules; and
in the Southern Hemisphere:
the front photovoltaic modules are arranged to face north, east, or both partially north and partially east; and
the rear photovoltaic modules are arranged to face an opposite direction from the front photovoltaic modules.

11. The asymmetric wave photovoltaic system of claim 1, wherein the front photovoltaic modules have higher efficiency than the rear photovoltaic modules and:
in the Northern Hemisphere, the front photovoltaic modules are arranged to face south, west, or both partially south and partially west; or
in the Southern Hemisphere, the front photovoltaic modules are arranged to face north, east, or both partially north and partially east.

12. The asymmetric wave photovoltaic system of claim 1, wherein a perimeter of the plurality of asymmetric wavelets in aggregate as projected downward onto a horizontal reference plane has a rhomboid or rhombus shape.

13. The asymmetric wave photovoltaic system of claim 1, wherein:
the second height at which the two lower corners of the rear photovoltaic modules are coupled is greater than the first height at which the two lower corners of the front photovoltaic module are coupled; and
the asymmetric wave photovoltaic system further comprises a plurality of wind deflectors, each positioned within a corresponding gap between an installation surface and a corresponding lower edge of a corresponding rear photovoltaic module within a rearmost row of the plurality of asymmetric wavelets.

14. The asymmetric wave photovoltaic system of claim 4, further comprising a plurality of pads disposed between the plurality of rails and an installation surface on which the asymmetric wave photovoltaic system is installed, wherein:
pads in a first subset of the plurality of pads are located directly beneath the plurality of fin assemblies and have a first pad thickness;
pads in a second subset of the plurality of pads are located longitudinally spaced apart along lengths of the plurality of rails from the plurality of fin assemblies and have a second pad thickness greater than the first pad thickness.

15. The asymmetric wave photovoltaic system of claim 4, wherein:
prior to being coupled through one or more of the plurality of fin assemblies to one or more of the plurality of asymmetric wavelets, each of the plurality of rails is crowned such that it has a concave upward curvature; and
after being coupled through the one or more of the plurality of fin assemblies to the one or more of the plurality of asymmetric wavelets, each of the plurality of rails is more flattened than prior to being coupled to the one or more of the plurality of asymmetric wavelets.

16. The asymmetric wave photovoltaic system of claim 1, further comprising a plurality of ballast clips coupled to a first subset of the plurality of rails and a second subset of the plurality of rails, wherein:
the first subset of the plurality of rails defines a first perimeter edge of the asymmetric wave photovoltaic system that extends normal to the rows of asymmetric wavelets;
the second subset of the plurality of rails defines a second perimeter edge of the asymmetric wave photovoltaic system opposite the first perimeter edge; and
each of the plurality of ballast clips is configured to support ballast.

17. The asymmetric wave photovoltaic system of claim 16, wherein each of the plurality of ballast clips includes:
a clip body;
a clip foot at one end of the clip body and that extends normal to the clip body;
a clip arm at an opposite end of the clip body and that extends parallel to the clip body; and
a clip hand that extends away from an end of the clip arm;
wherein the clip hand is configured to be received within an open slot of a corresponding rail of the first or second subsets of the plurality of rails to couple the ballast clip to the corresponding rail.

18. The asymmetric wave photovoltaic system of claim 4, further comprising a plurality of compliant cables that couple the plurality of rails to a plurality of surface footings, wherein each of the plurality of rails spans at least one gap between sequential surface footings of the plurality of surface footings.

19. The asymmetric wave photovoltaic system of claim 4, further comprising at least one tie-down that includes:
a cross-bar with one end coupled to a first of the plurality of rails and an opposite end coupled to a second of the plurality of rails that is spaced apart from and parallel to the first of the plurality of rails; and
an L-bracket with a base that is coupled to an anchor and an upright that is coupled to the cross-bar.

20. The asymmetric wave photovoltaic system of claim 4, further comprising a plurality of snow feet arranged normal to the plurality of rails, each including a cradle positioned immediately beneath and in direct contact with a corresponding one of the plurality of fin assemblies, wherein the plurality of snow feet is configured to support most of a total weight of the asymmetric wave photovoltaic system.

21. The asymmetric wave photovoltaic system of claim 20, wherein:
each of the plurality of snow feet further includes two snow foot rails arranged normal to the plurality of rails;
at least one of the two snow foot rails spans a gap between two parallel lines of the plurality of rails;
a first end of the cradle displaced to a first side of the corresponding one of the plurality of fin assemblies is coupled to a first one of the two snow foot rails by a first clamp, a first T-bolt, and a first nut included in the snow foot; and
a second end of the cradle opposite the first end and displaced to a second side of the corresponding one of the plurality of fin assemblies is coupled to a second one of the two snow foot rails by a second clamp, a second T-bolt, and a second nut included in the snow foot.

22. The asymmetric wave photovoltaic system of claim 4, wherein:
the asymmetric wave photovoltaic system is configured to be installed on a sloped installation surface with a plurality of spaced apart ridges that each has a ridge height;
the asymmetric wave photovoltaic system further comprises a plurality of pads disposed between the plurality of rails and the sloped installation surface at spaces between the plurality of spaced apart ridges; and
the plurality of pads each has a pad height that is greater than the ridge height to support the plurality of rails, the plurality of fin assemblies and the plurality of asymmetric wavelets above and avoiding direct contact with the plurality of spaced apart ridges.

23. The asymmetric wave photovoltaic system of claim 22, further comprising a ridge clip configured to couple one of the plurality of spaced apart ridges to one of the plurality of rails.

24. An asymmetric wave photovoltaic system, comprising:
at least one asymmetric wavelet, wherein:
the at least one asymmetric wavelet includes front and rear photovoltaic modules of equal size;
the front and rear photovoltaic modules are coupled together to form a peak of the at least one asymmetric wavelet;
the front photovoltaic module is supported at a first angle; and
the rear photovoltaic module is supported at a second angle that is different than the first angle.

25. The asymmetric wave photovoltaic system of claim 24, wherein each of the front and rear photovoltaic modules includes a cylindrically curved photovoltaic module.

26. The asymmetric wave photovoltaic system of claim 25, wherein each of the front and rear photovoltaic modules includes two opposite straight edges that run parallel to the peak of the at least one asymmetric wavelet and two opposite curved edges coupled between the two opposite straight edges at opposite ends of the two opposite straight edges.

27. The asymmetric wave photovoltaic system of claim 26, wherein each of the front and rear photovoltaic modules further includes at least one tension cable with a first end coupled to one of the two opposite straight edges and a second end coupled to another of the two opposite straight edges.

28. The asymmetric wave photovoltaic system of claim 25, wherein a depth of curvature of each of the cylindrically curved photovoltaic modules is in a range of 1-4 inches over a linear length of each cylindrically curved photovoltaic module of about 50 inches.

29. The asymmetric wave photovoltaic system of claim 26, wherein an arc length of each cylindrically curved photovoltaic module is in a range of 50-200 inches.
